(19) United States
(12) Patent Application Publication
(10) Pub. No.: US 2026/0251575 A1
(43) Pub. Date: Aug. 27, 2026

(54) IMPROVED RAMAN SPECTROSCOPY AND COMBINED RAMAN-MATRIX-ASSISTED LASER DESORPTION/IONIZATION (MALDI) IMAGING WORKFLOW WITH THE ADDITION OF AROMATIC COMPOUNDS

(71) Applicant: The Johns Hopkins University, Baltimore, MD (US)

(72) Inventors: Ethan YANG, Baltimore, MD (US); Jeong Hee KIM, Baltimore, MD (US); Kristine GLUNDE, Baltimore, MD (US); Ishan BARMAN, Baltimore, MD (US); Caitlin TRESSLER, Baltimore, MD (US)

(21) Appl. No.: 18/854,746

(22) PCT Filed: Apr. 19, 2023
(86) PCT No.: PCT/US2023/019161

§ 371 Date: Oct. 7, 2024

Related U.S. Application Data
(60) Provisional application No. 63/332,460, filed on Apr. 19, 2022.

(51) Int. Cl. G01N 21/65

(52) U.S. Cl. CPC G01N 21/65

(57) ABSTRACT

Disclosed are methods for enhancing a Raman intensity of a sample by adding to the sample an aromatic compound having an absorbance ranging from about 250 nm to about 500 nm, and also, a solvent and a matrix-assisted laser desorption/ionization (MALDI) matrix. Workflows for a combined Raman-MALDI imaging instrument also are disclosed.

### BACKGROUND

Raman spectroscopy is a sensitive technique that provides the overall molecular vibrational signature of a sample. Its nondestructive nature has made it possible for non-perturbative imaging of cells, tissue and even permitted in vivo measurements in organisms, animals and humans. Furthermore, advances in this field have made possible high resolution mapping, known as Raman spectroscopy imaging (RSI). The current setup, however, is slow and cumbersome and the acquired spectral information is often challenging to directly interpret in molecular terms.

Conversely, matrix-assisted laser desorption/ionization (MALDI) mass spectrometry imaging (MSI) is a powerful analytical technique that can reveal the molecular distribution of hundreds of molecules in one single run. Current advancements have improved the overall speed of MSI to 10 kHz, making a typical imaging run at 50 μm pixel size at less than one hour. Nonetheless, MALDI MSI cannot analyze live samples and has yet to reach submicron resolution commercially.

The strengths and weaknesses of RSI and MSI reveal a strong compatibility and complementarity of these two techniques. Currently, most experiments that take advantage of RSI and MSI require two separate samples, one sample for RSI and another sample for MSI. The few studies that do combine these techniques begin with a standard RSI experiment, then proceed to MSI after the addition of the MALDI matrix. This laborious workflow leaves significant room for improvement and innovation, especially in streamlining the sample preparation process for the imaging modalities and reducing overall analysis time.

### SUMMARY

In some aspects, the presently disclosed subject matter provides a method for obtaining a Raman spectrum of a sample, the method comprising:
(a) providing a sample;
(b) depositing one or more aromatic additives onto the sample; and
(c) obtaining a Raman spectrum of the sample.

In certain aspects, the one or more aromatic additives have an absorbance ranging from about 250 nm to about 500 nm. In particular aspects, the one or more aromatic comprise a matrix-assisted laser desorption/ionization (MALDI) matrix. In more particular aspects, the MALDI matrix is selected from alpha-cyano-4-hydroxycinnamic acid (CHCA), sinapinic acid (SA) ((2E)-3-(4-hydroxy-3,5-dimethoxyphenyl)prop-2-enoic acid), 2,5-dihydroxybenzoic acid (DHB), 3,4-dihydroxycinnamic acid (DHBA), 2-mercaptobenzothiazole (MBT), trans-3-indoleacrylic acid (IAA), 5-chloro-2-mercaptobenzothiazole (CMBT), 2-hydroxyphenylbenzoic acid (HPBA), 2-amino-4-methyl5-nitropyridine (2a4m5n), 2,6-diydroxyacetophenone (DHAP), trihydroxyacetophenone (THAP), ferulic acid (FA) ((2E)-3-(4-hydroxy-3-methoxyphenyl)prop-2-enoic acid), picolinic acid (PA) (pyridine-2-carboxylic acid), 3-hydroxy picolinic acid (HPA) (3-hydroxypyridine-2-carboxylic acid), caffeic acid (CA), 1,5-diaminonaphthalene (DAN), 9-aminoacridine (9-AA), norharmane (nH), nicotinic acid, pyrozinoic acid, vanillic acid, succinic acid, glycerol, urea, tris buffer (pH 7.3), other cinnamic acid derivatives, and combinations thereof.

In certain aspects, the MALDI matrix further comprises a solvent. In particular aspects, the solvent is selected from acetonitrile, water, methanol, ethanol, propanol, acetone, chloroform, N,N-dimethylformamide, tetrahydrofuran and combinations thereof.

In certain aspects, the MALDI matrix further comprises a counter ion or acid additive. In particular aspects, the counter ion or acid additive is selected from H₃PO₄, HNO₃, H₂SO₄, HCl, and trifluoroacetic acid (TFA).

In certain aspects, the depositing of the one or more aromatic additives onto the sample is accomplished by manual spraying, manual dry sieve deposition, robotic spraying, sublimation, automatic spot printing or combinations thereof.

In certain aspects, the method further comprises high-resolution Raman mapping.

In certain aspects, the method further comprises obtaining a MALDI spectrum of the sample. In particular aspects, the method further comprises MALDI imaging.

In certain aspects, the sample is snap frozen or heat treated.

In certain aspects, the method further comprises embedding the sample in an embedding medium, matrix, or resin. In particular aspects, the embedding medium comprises an M-1 embedding medium, an optimal cutting temperature (OCT) embedding medium, gelatin embedding medium, carboxymethyl cellulose (CMC) medium or ice.

In certain aspects, the method further comprises cryo-sectioning the sample. In particular aspects, the sample is cryo-sectioned onto a microscopy glass slide, an indium tin oxide (ITO)-coated slide or other conductive slides, including but not limited to gold slides, aluminum oxide slides, steel plates, among others.

In certain aspects, the method further comprises chemical derivatization of the sample.

In certain aspects, the method comprises analyzing one or more intact proteins. In certain aspects, the method further comprises analyzing one or more tryptic peptides. In certain aspects, the method comprises analyzing one or more N-glycans, peptides, lipids, metabolites, drug molecules, and drug metabolites in a spatially resolved manner.

In certain aspects, the sample is selected from an organ, a tissue, a cell, bacteria, fungi, a plant, a fruits, another lifeform, and an inanimate object.

In certain aspects, a Raman signal of the sample with the one or more aromatic compounds deposited thereon is greater than a Raman signal of the sample without the one or more aromatic compounds deposited thereon.

Certain aspects of the presently disclosed subject matter having been stated hereinabove, which are addressed in whole or in part by the presently disclosed subject matter, other aspects will become evident as the description proceeds when taken in connection with the accompanying Examples and Figures as best described herein below.

### BRIEF DESCRIPTION OF THE FIGURES

The patent or application file contains at least one drawing executed in color. Copies of this patent or patent application publication with color drawings will be provided by the Office upon request and payment of the necessary fee.

FIG. 1 shows a representative experimental workflow for RaMALDI imaging. A fresh-frozen tissue section is cryo-sectioned and thaw-mounted onto a conductive ITO microscopy slide. This is followed by MALDI matrix application by spraying of, for example, DAN, onto the tissue section. DAN was identified by an extensive optimization process to have the least influence on spectral quality of RSI and MALDI MSI measurements. The prepared tissue section is first utilized for RSI and then the same sample is subjected to MALDI MSI measurement. This workflow enables the seamless production of two separate images of a single tissue section without compromising the spectral or spatial quality of the hyperspectral datasets;

FIG. 2 demonstrates RaMALDI imaging of Sharpie® markers. Pink, Brown, and Red (from top to bottom) markings on an ITO slide underneath 0.0016 mg/mm² DAN matrix were measured using RaMALDI imaging. Both RSI and MSI of RaMALDI imaging were individually processed and images reconstructed at unique Raman and m/z peaks, respectively, for each Sharpie® marker color. Identified Raman and m/z peaks: 1650 cm⁻¹ and m/z⁺443.4 for pink, 1406 cm⁻¹ and m/z 649.1 for brown, and 621 cm⁻¹ and m/z⁺415.3 for red, were selected as the most prominent peaks compared to background signal. Raman peaks at 1650 cm⁻¹, 1406 cm⁻¹, and 621 cm⁻¹ mainly arise from Rhodamine B and 6G, azo compounds, and naphthol and Rhodamine 6G for pink, brown, and red pigments, respectively. MSI peaks at m/z⁺443.4 and m/z⁺415.3 result from Rhodamine 6G and its derivatives. The MSI peak at m/z⁻ 649.1 arises from red dyes, such as direct red 28, frequently used in brown-colored markers. Scale bar=1 mm;

FIG. 3 is a comparison of biological signals obtained from a traditional RSI approach against the presently disclosed combined RSI/MSI workflow with aromatic additives;

FIG. 4 shows the protective effects of aromatic additives for biological samples during RSI. With the addition of the aromatic additive, the biological sample signal remains stable over a period of at least four days, whereas the sample without the additive loses signal intensity steadily over the same timeframe;

FIG. 5 is the presently disclosed workflow made possible with a fully combined Raman-MALDI imaging experiment;

FIG. 6A, FIG. 6B, FIG. 6C, FIG. 6D, and FIG. 6E demonstrate RaMALDI imaging of mouse kidney tissue section. RaMALDI imaging results are shown for RSI, followed by MSI of a representative coronal mouse kidney tissue section on an ITO slide sprayed with DAN matrix and imaged at 100 μm spatial resolution. (FIG. 6A) H&E-stained image of the same kidney tissue section was acquired following RaMALDI imaging. Anatomical structures of renal cortex, renal medulla, and capsule are labeled in the image. (FIG. 6B) K-means bisecting segmentation results of RaMALDI MSI data from positive (POS) and negative (NEG) MSI of the same section. (FIG. 6C) RSI data (top row) and MSI data (middle and bottom rows) of RaMALDI imaging. Two chemical component images (Component 1, Component 2) from the MCR-ALS model are displayed for RSI data. MALDI MS images are shown for two m/z's for positive ion mode identified as specific phosphatidylcholines (PC) and two m/z's for negative ion mode identified as specific phosphatidylserines (PS). Scale bar=2 mm. (FIG. 6D) MCR-ALS resolved RaMALDI-RSI spectra of component 1 (nucleic acid-rich) and component 2 (lipid-rich), corresponding to (FIG. 6C) RaMALDI-RSI. Pure chemical spectra were decomposed from preprocessed RaMALDI-RSI spectra in the biological fingerprint region (1000-1800 cm⁻¹) based on MCR-ALS model corresponding to (FIG. 6C). (FIG. 6E) RaMALDI-MSI spectra of positive ion (top) and negative ion (bottom) modes corresponding to (FIG. 6C) M/z signals shown as images in (FIG. 6C) are highlighted in red in the expanded spectral regions;

FIG. 7A, FIG. 7B, FIG. 7C, FIG. 7D, and FIG. 7E demonstrate RaMALDI imaging of brain tissue section at 50 μm lateral spatial resolution. RaMALDI imaging results are shown for RSI, followed by MSI of a horizontal brain tissue section on an ITO slide sprayed with DAN matrix and imaged at 50 μm spatial resolution. (FIG. 7A) H&E image of brain tissue section showing gray matter (GM) and white matter (WM) as labeled in the image. (FIG. 7B) K-means bisecting segmentation results of RaMALDI MSI data from positive (POS) and negative (NEG) MSI of the same section. (FIG. 7C) RSI data (top row) and MSI data (middle and bottom row) of RaMALDI imaging. Two chemical component images (Component 1, Component 2) from the MCR-ALS model are displayed for RSI data. MALDI MS images are shown for two m/z's for positive ion mode identified as specific phosphatidylcholines (PC) and two m/z's for negative ion mode identified as a specific phosphatidylinositol (PI) and a specific sulfatide. Scale bar=2 mm. (FIG. 7D) MCR-ALS resolved RaMALDI-RSI spectra of component 1 (gray matter) and component 2 (white matter). Pure chemical spectra were decomposed from preprocessed RaMALDI-RSI spectra in the biological fingerprint region (1000-1800 cm⁻¹) based on the MCR-ALS model corresponding to (FIG. 7C). (FIG. 7E) RaMALDI-MSI spectra of positive ion (top) and negative ion (bottom) modes corresponding to (FIG. 7C)). M/z signals displayed as images in (FIG. 7C) are highlighted in red in the expanded spectral regions;

FIG. 8A, FIG. 8B, FIG. 8C, FIG. 8D, and FIG. 8E demonstrate RaMALDI imaging of brain tissue section at 5 μm lateral spatial resolution. RaMALDI imaging results are shown for RSI, followed by MSI of a horizontal brain tissue section on an ITO slide sprayed with DAN matrix and imaged at 5 μm spatial resolution in the region of the cerebellum. (FIG. 8A) H&E images of brain tissue section showing the three layers of molecular, Purkinje, and granular layer in gray matter and white matter as labeled in the image. Scale bar=500 μm (left) and 200 μm (right). (FIG. 8B) RSI data (left) and MSI data (right) of RaMALDI imaging. Four chemical component images (Component 1, Component 2, Component 3, Component 4) from the MCR-ALS model are displayed for RSI data. MALDI MS images are shown for four m/z's for positive ion mode identified as three specific phosphatidylcholines (PC) and a specific lysophosphatidic acid (LPA). Scale bar=200 μm. (FIG. 8C) MCR-ALS resolved RaMALDI-RSI spectra of component 1 (gray matter), component 2 (white matter; cholesterol- and lipid-rich), component 3 (gray matter), and component 4 (white matter; lipid-rich). Pure chemical spectra were decomposed from preprocessed RaMALDI-RSI spectra in the biological fingerprint region (1000-1800 cm⁻¹) based on the MCR-ALS model corresponding to (FIG. 8B). (FIG. 8D) RaMALDI-MSI spectra of positive ion (top) and negative ion (bottom) modes corresponding to (FIG. 8B)). M/z signals shown as images in (B) are highlighted in red in the expanded spectral regions;

FIG. 9A, FIGS. 9B, and 9C show a representative RaMALDI optimization process to test Raman spectroscopy compatibility with MALDI matrices. To test and optimize the compatibility of Raman spectroscopy with MALDI matrices, we tested Raman spectra of (FIG. 9A) pure MALDI matrices prayed onto ITO slides and (FIG. 9B) pink Sharpie® marker drawings on ITO slides sprayed with the six most common MALDI matrices-1,5-diaminonapthalene (DAN), alpha-cyano-4-hydroxycinnamic (CHCA), 2,5-dihydroxybenzoic acid (DHB), 9-aminoacridine (9AA), norharmane (nH), and sinapic acid (SA)—and without any matrix (NM, no matrix) on ITO slides. (FIG. 9C) We then compared spectra of pink Sharpie® marker drawings on ITO slides (top 2 spectra) and quartz slides (bottom 2 spectra), which are standard protocol for Raman measurement both with and without DAN matrix sprayed over the drawings.

FIG. 10 shows a representative RaMALDI optimization process to determine matrix density. To optimize the density of matrix deposition, we tested Raman spectra of pink Sharpie® marker with 1,5-diaminonapthalene (DAN) sprayed at varying density. Number of matrix layers sprayed onto an ITO slide corresponded to matrix density as follows: 0x=0 mg/mm², 1x=0.0004 mg/mm², 2x=0.0008 mg/mm², 3x=0.0012 mg/mm², 4x=0.0016 mg/mm², and 8x=0.0032 mg/mm²;

FIG. 11 shows RaMALDI-Raman spectra of Sharpie® markers of all colors. Raman spectra of Sharpie® marker drawings on ITO slide sprayed with DAN matrix are shown. Unique Raman peaks (shaded regions) used for evaluating RSI quality and signal scoring as shown in FIG. 2 and Table 1;

FIG. 12 shows RaMALDI-positive ion mode MALDI MSI spectra of Sharpie® markers of all colors. MALDI MSI spectra of Sharpie® marker drawings on ITO slide sprayed with DAN matrix are shown. Unique MS peaks (shaded regions) used for evaluating MALDI MSI quality and signal scoring as shown in FIG. 2 and Table 1;

FIG. 13 shows RaMALDI-negative ion mode MALDI MSI spectra of Sharpie® markers of all colors. MALDI MSI spectra of Sharpie® marker drawings on ITO slide sprayed with DAN matrix are shown. Unique MS peaks (shaded regions) used for evaluating MALDI MSI quality and signal scoring as shown in FIG. 2 and Table 1;

FIG. 14A, FIG. 14B, and FIG. 14C show the sample protection capability of RaMALDI imaging in liver tissue homogenates. (FIG. 14A) RaMALDI-Raman liver homogenate spectra. (FIG. 14B) Comparison of Raman liver homogenate spectra measured by RaMALDI imaging (blue), as compared to standard Raman preparation on a quartz slide with (yellow) and without (orange) DAN matrix deposition. (FIG. 14C) Changes observed over time in normalized Raman intensity at 1586 cm⁻¹ (marked with gray shading in FIG. 14B) when preparing the liver homogenate sample with DAN matrix on ITO slide for (FIG. 14C1) RaMALDI imaging versus without DAN matrix on quartz slide for (FIG. 14C2) standard Raman;

FIG. 15A and FIG. 15B show the MS/MS spectra in positive ion mode of (FIG. 15A) precursor peak of m/z 782.4, (FIG. 15B) fragmentation of m/z 782.4. Chemical structures of characteristic fragments (boxed in red) are shown;

FIG. 16A and FIG. 16B show the MS/MS spectra of in positive ion mode (FIG. 16A) precursor peak of m/z 792.3, (FIG. 16B) fragmentation of m/z 792.3. Chemical structures of characteristic fragments (boxed in red) are shown;

FIG. 17A and FIG. 17B show the MS/MS spectra in negative ion mode of (FIG. 17A) precursor peak of m/z 664.3, (FIG. 17B) fragmentation of m/z 664.3. Chemical structures of characteristic fragments (boxed in red) are shown;

FIG. 18A and FIG. 18B show MS/MS spectra in negative ion mode of (FIG. 18A) precursor peak of m/z 786.4, (FIG. 18B) fragmentation of m/z 786.4. Chemical structures of characteristic fragments (boxed in red) are shown;

FIG. 19A and FIG. 19B show MS/MS spectra in positive ion mode of (FIG. 19A) precursor peak of m/z 838.4, (FIG. 19B) fragmentation of m/z 838.4. Chemical structures of characteristic fragments (boxed in red) are shown;

FIG. 20A and FIG. 20B show the MS/MS spectra in positive ion mode of (FIG. 20A) precursor peak of m/z 844.3, (FIG. 20B) fragmentation of m/z 844.3. Chemical structures of characteristic fragments (boxed in red) are shown;

FIG. 21A and FIG. 21B show the MS/MS spectra in negative ion mode of (FIG. 21A) precursor peak of m/z 885.8, (FIG. 21B) fragmentation of m/z 885.8. Chemical structures of characteristic fragments (boxed in red) are shown;

FIG. 22A and FIG. 22B show the MS/MS spectra in negative ion mode of (FIG. 22A) precursor peak of m/z 889.6, (FIG. 22B) fragmentation of m/z 889.6. Chemical structures of characteristic fragments (boxed in red) are shown;

FIG. 23A and FIG. 23B show the MS/MS spectra in positive ion mode of (FIG. 23A) precursor peak of m/z 806.4, (FIG. 23B) fragmentation of m/z 806.4. Chemical structures of characteristic fragments (boxed in red) are shown;

FIG. 24A and FIG. 24B show the MSMS spectra in positive ion mode of (FIG. 24A) precursor peak of m/z 405.3, (FIG. 24B) fragmentation of m/z 405.3. Chemical structures of characteristic fragments (boxed in red) are shown;

FIG. 25A and FIG. 25B show the MS/MS spectra in positive ion mode of (FIG. 25A) precursor peak of m/z 834.4, (FIG. 25B) fragmentation of m/z 834.4. Chemical structures of characteristic fragments (boxed in red) are shown; and

FIG. 26A and FIG. 26B show the MS/MS spectra in negative ion mode of (FIG. 26A) precursor peak of m/z 826.4, (FIG. 26B) fragmentation of m/z 826.4. Chemical structures of characteristic fragments (boxed in red) are shown.

### DETAILED DESCRIPTION

The presently disclosed subject matter now will be described more fully hereinafter with reference to the accompanying Figures, in which some, but not all embodiments of the inventions are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated Figures. Therefore, it is to be understood that the presently disclosed subject matter is not to be limited to the specific embodiments disclosed and that modifications and other embodiments are intended to be included within the scope of the appended claims.

I. Improved Raman Spectroscopy and Combined Raman-Matrix-Assisted Laser Desorption/Ionization (Maldi) Imaging Workflow with the Addition of Aromatic Compounds

Identifying disease-specific molecular profiles requires an understanding of how biomolecules are altered in diseased tissue and the surrounding microenvironment. The development of such profiles ideally is achieved through an approach or a combination of approaches that measures biomolecular features in a high-throughput and spatially-resolved manner. Raman spectroscopy, including Raman spectroscopy imaging (RSI), and matrix-assisted laser desorption/ionization (MALDI) mass spectrometry (MS), including MALDI mass spectrometry imaging (MSI), are two techniques particularly well suited for the analysis of diseased tissue, or tissue suspected of being associated with a disease, condition, or disorder.

In Raman spectroscopy, inelastic scattering of a photon occurs when a small fraction of the scattered light (approximately 1 in 10⁷) is scattered, leading to scattered photons with a frequency different from that of the incident photon. Two types of Raman scattering are observed when energy exchange occurs between the incident photon and a molecule: Stokes scattering (the molecule absorbs energy) and anti-Stokes scattering (the molecule loses energy). Since the energy levels are unique for every molecule and the frequency of light scattered from a molecule is based on the structural characteristics of the chemical bonds, Raman spectrum is highly chemical specific.

More recently, Raman spectroscopy also has been explored for biomedical applications because it can provide detailed information on the chemical composition of cells and tissues. The Raman spectrum of a cell or tissue provides a biochemical “fingerprint” containing molecular-level information about all the biopolymers inside the cell without the need of an exogenous label, which can be used to characterize the distribution of multiple cellular components and study the dynamics of sub-cellular reactions with excellent spatial resolution. Raman spectroscopy has shown tremendous promise for the analysis of biological processes within living cells, such as cell cycle dynamics, cell differentiation, and cell death. Further, many diseases can lead to changes in molecular composition of the affected tissues. Raman spectroscopy can reflect these changes in many cases. Over the last decade, the diagnostic potential of Raman spectroscopy has been demonstrated in cancers of various organs including the esophagus, breast, lung, bladder, skin, among others. Further, Raman spectroscopy also has been demonstrated for the diagnosis of certain vascular diseases, such as vulnerable plaque detection in atherosclerosis.

Mass spectrometry imaging (MSI) has the chemical sensitivity and specificity for the spatial analysis of biological tissue sections and can detect hundreds of molecules simultaneously in a single experiment. Thus, MSI is a powerful tool for mapping the molecular composition of a tissue section. The emergence of matrix-assisted laser desorption/ionization (MALDI) technology has facilitated the analysis of large biomolecules, such as proteins, and large metabolites, such as lipids, including phospholipids, and in study of reaction pathways involved in lipid metabolism within biological systems, i.e., lipidomics, without the need for any labelling. Further, high-spatial resolution MALDI-MSI is capable of reaching single-cell scale. MALDI-MSI can provide insight into the spatial distribution of proteins, peptides, lipids, glycans, drugs, and small molecules in tissue sections.

Analysis of a biological sample by matrix-assisted laser desorption ionization (MALDI) is typically a three step process. First, a matrix is mixed with the sample. Generally, the MALDI matrix can be any material that solubilizes biomolecules, absorbs light energy at a frequency easily accessible by a laser, and is unreactive with respect to biomolecules. Representative examples of MALDI matrices are provided hereinbelow.

Typical workflows for MALDI-MSI include tissue harvesting, tissue preservation, tissue sectioning, sample preparation, matrix application, MSI data acquisition, post-MSI histopathological staining, image co-registration, identification of candidate masses of interest, pathway analysis, data integration, and data interpretation.

In terms of tissue preservation, fresh-frozen (FF) tissues can be used in MALDI-MSI. For example, FF samples for MSI can be stored at −80° C., which are stable for at least one year, after which peptide/protein degradation can occur. Traditional forms of tissue preservation, such as formalin fixation and paraffin embedding (FFPE), can be used in MALDI-MSI under some circumstances. The paraffin required for preservation and sectioning of formalin-fixed tissue, as well as the crosslinking of proteins, can interfere with molecular desorption and ionization in MALDI-MSI.

Sample preparation can depend on the molecular class and tissue type to be imaged. The first step in sample preparation is tissue sectioning, and in the case of an FF sample, cryo-sectioning. Since MSI is a surface analysis technique, samples must be sectioned thinly, e.g., between about 2 μm to about 7 μm for FFPE and about 7 μm to about 20 μm for FF tissue sections.

Additional sample preparation steps depend on the type of tissue to be analyzed. For example, for FF tissue, no additional sample preparation is required other than applying the matrix. In contrast, for FFPE-prepared tissue, a multi-step process is required, including deparaffinization (e.g., by heating and washing), tissue rehydration, and antigen retrieval. On-tissue enzymatic digestion (OTED) or additional chemical treatment steps, such as on-tissue chemical derivatization (OTCD), also can be necessary depending on the molecular class to be analyzed. Sample preparation also can include a drying step and an optional washing step to select specific molecular classes and/or to remove endogenous compounds, such as lipids and physiological salts, from the sample, which can compete with analytes during ionization and cause ion suppression.

The last and essential step in MALDI-MSI sample preparation is matrix application. The choice of matrix, solvent system, temperature, and methods of matrix application influence extraction and subsequent ionization of the analyte of interest. Further, the method of matrix application can affect the degree of potential delocalization and the matrix crystal size.

Some fundamental properties for MALDI-MSI matrices include, but are not limited to: (i) display a strong and efficient absorption in the region of commonly used UV or IR laser wavelengths; (ii) minimal matrix background signals and adducts with target analytes, i.e., chemical noise; (iii) an ability to interact with analytes to form co-crystals; and (iv) must be able to effectively ionize the analytes.

A MALDI-MSI matrix suitable for tissue imaging also should: (i) have high vacuum stability in the mass spectrometer for several hours; (b) be reproducible and practical in a routine laboratory; (c) generate uniform, small crystals; (d) in some applications, e.g., unknown biomarkers, be suitable for positive and negative ion modes; (e) be tolerable of the presence of physiological salts, thereby allowing for the direct application of matrices without additional washes; and (f) be chemically stable, low cost, low toxicity, and, under specific conditions, promote analyte fragmentation.

Representative methods for applying the matrix include, but are not limited to, wet coating by a nebulizing sprayer or dry coating, e.g., by a sublimation process.

Several different classes of substances have been tested and evaluated as MALDI-MSI matrices including small organic molecules, graphene, graphene oxide, nanoparticles, metal oxides, ionic liquids, and conjugated polymers. Small organic molecules are the most common MALDI-MSI matrices. Representative MALDI-MSI matrices include, but are not limited to, alpha-cyano-4-hydroxycinnamic acid (CHCA), sinapinic acid (SA) ((2E)-3-(4-hydroxy-3,5-dimethoxyphenyl)prop-2-enoic acid), 2,5-dihydroxybenzoic acid (DHB), 3,4-dihydroxycinnamic acid (DHBA), 2-mercaptobenzothiazole (MBT), trans-3-indoleacrylic acid (IAA), 5-chloro-2-mercaptobenzothiazole (CMBT), 2-hydroxyphenylbenzoic acid (HPBA), 2-amino-4-methyl5-nitropyridine (2a4m5n), 2,6-diydroxyacetophenone (DHAP), trihydroxyacetophenone (THAP), ferulic acid (FA) ((2E)-3-(4-hydroxy-3-methoxyphenyl)prop-2-enoic acid), picolinic acid (PA) (pyridine-2-carboxylic acid), 3-hydroxy picolinic acid (HPA) (3-hydroxypyridinc-2-carboxylic acid), caffeic acid (CA), 1,5-diaminonaphthalene (DAN), 9-aminoacridine (9-AA), norharmane (nH), nicotinic acid, pyrozinoic acid, vanillic acid, succinic acid, glycerol, urea, tris buffer (pH 7.3), other cinnamic acid derivatives, and combinations thereof.

Rationally designed and newly disclosed matrices for MALDI-MSI also are suitable for use with the presently disclosed subject matter including, but not limited to, 1,5-diaminonaphthalene, 4-phenyl-α-cyanocinnamic acid amide, alkylated 2,5-DHB, 1,8-di(piperidinyl)-naphthalene, 4,5-(bis(dimethylamino) naphthalen-1-yl) furan-2,5-dione, (E)-4-(2,5-dihydroxyphenyl) but-3-en-2-one (2,5-cDHA), 2-(methylamino)benzoic acid (2-COOH)—NHMe), N-phenyl-2-naphthylamine (PNA), N-(1-naphthyl)ethylenediamine (NEDC), 3,4-dimethoxycinnamic acid (DMCA), 3-aminophthalhydrazide (3-APH), 2,3-dicyanohydroquinone (DCH), (2-[(2E)-3-(4-tert-butylphenyl)-2-methylprop-2-enylidene]malononitrile (DCTB), IR-780, 1,6-diphenyl-1,3,5-hexatriene (DPH), and 1,1′-binaphthyl-2,2′-diamine (BNDM). (See Zhou, Q., Fulop, A., and Hopf, C., Analytical and Bioanalytical Chemistry (2021) 413:2599-2617).

MALDI matrices can be dissolved in a suitable solvent, such as acetonitrile, or can be otherwise dry deposited on the sample, for example, through sublimation. MALDI matrices also can include one or more acid additives, including, but not limited to, H₃PO₄, HNO₃, H₂SO₄, HCl, and trifluoroacetic acid (TFA). In some embodiments, the acid additive is TFA. Acid additives serve as a proton donor to facilitate ionization of the sample. Basic MALDI matrices also have been used (depending on the mode of ionization, e.g., for positive or negative ions). Salt additives are possible for MALDI matrices, as well. (See Colsch, B., Woods, A. S., Glycobiology (2010) 20:661-667.) MALDI matrices typically have a strong absorption in either the UV or visible wavelength range so that they rapidly and efficiently absorb the incident laser irradiation. This characteristic is commonly associated with the presence of several conjugated double bonds in the organic compound comprising the matrix, which also can be functionalized with one or more polar groups, thereby facilitating their use in aqueous solutions.

To that end, a matrix solution comprising a mixture of water and an organic solvent allows both hydrophobic and hydrophilic molecules to dissolve in the solution. This solution is spotted onto a MALDI plate, such as a metal target plate. The solvent vaporizes, leaving a crystallized matrix with the sample embedded therein. The plate is then introduced into the mass spectrometer. In the next step a pulsed laser irradiates the sample, causing ablation and desorption of the sample and matrix material. Finally, the sample molecules are ionized by being protonated or deprotonated in the plume of ablated material and then they can be accelerated into the mass spectrometer for detection.

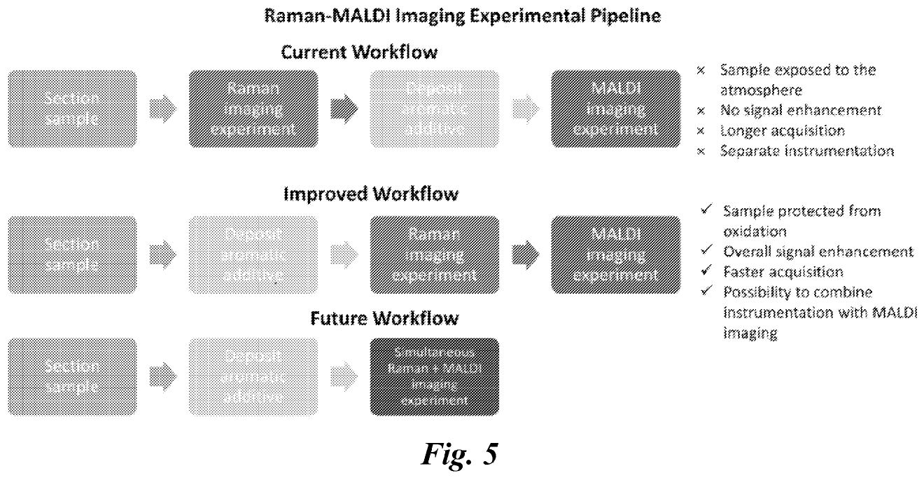

Currently, combined RSI and MSI workflows require multiple sections and long experimental times. For RSI alone, one high-resolution mapping experiment can take up to one week, requiring multiple freeze-thaw cycles and long exposure to the environment. The presently disclosed workflow (see, e.g., FIG. 5) reduces the sampling time to one workday and minimizes sample degradation.

Further, the ability to analyze the same sample with RSI and MSI simplifies the downstream data analysis by removing the need for computational realignment and eliminating any artefacts from this step. This combinatory approach also reduces the sample requirements and overall sample preparation time, making it possible to run experiments on incredibly precious samples.

Accordingly, the presently disclosed subject matter demonstrates for the first time RaMALDI imaging, a streamlined, integrated multimodal imaging workflow of Raman spectroscopy imaging (RSI) and matrix-assisted laser desorption/ionization mass spectrometry imaging (MALDI MSI), which is performed on a single sample and uses one sample preparation protocol. RaMALDI imaging of various tissues effectively integrates molecular information acquired from both RSI and MALDI MSI of the same sample.

In some embodiments, the presently disclosed subject matter provides a method for obtaining a Raman spectrum of a sample, the method comprising:
(a) providing a sample;
(b) depositing one or more aromatic additives onto the sample; and
(c) obtaining a Raman spectrum of the sample.

In certain embodiments, the one or more aromatic additives have an absorbance ranging from about 250 nm to about 500 nm. In particular embodiments, the one or more aromatic comprise a matrix-assisted laser desorption/ionization (MALDI) matrix. In more particular embodiments, the MALDI matrix is selected from alpha-cyano-4-hydroxycinnamic acid (CHCA), sinapinic acid (SA) ((2E)-3-(4-hydroxy-3,5-dimethoxyphenyl)prop-2-enoic acid), 2,5-dihydroxybenzoic acid (DHB), 3,4-dihydroxycinnamic acid (DHBA), 2-mercaptobenzothiazole (MBT), trans-3-indoleacrylic acid (IAA), 5-chloro-2-mercaptobenzothiazole (CMBT), 2-hydroxyphenylbenzoic acid (HPBA), 2-amino-4-methyl5-nitropyridine (2a4m5n), 2,6-diydroxyacetophenone (DHAP), trihydroxyacetophenone (THAP), ferulic acid (FA) ((2E)-3-(4-hydroxy-3-methoxyphenyl)prop-2-enoic acid), picolinic acid (PA) (pyridine-2-carboxylic acid), 3-hydroxy picolinic acid (HPA) (3-hydroxypyridine-2-carboxylic acid), caffeic acid (CA), 1,5-diaminonaphthalene (DAN), 9-aminoacridine (9-AA), norharmane (nH), nicotinic acid, pyrozinoic acid, vanillic acid, succinic acid, glycerol, urea, tris buffer (pH 7.3), other cinnamic acid derivatives, and combinations thereof.

In certain embodiments, the MALDI matrix further comprises a solvent. In particular embodiments, the solvent is selected from acetonitrile, water, methanol, ethanol, propanol, acetone, chloroform, and combinations thereof.

In certain embodiments, the MALDI matrix further comprises a counter ion or acid additive. In particular embodiments, the counter ion or acid additive is selected from H₃PO₄, HNO₃, H₂SO₄, HCl, and trifluoroacetic acid (TFA).

In certain embodiments, the depositing of the one or more aromatic additives onto the sample is accomplished by manual spraying, manual dry sieve deposition, see, e.g., htximaging.com/htxan36, robotic spraying, sublimation, automatic spot printing, see, e.g., Gustafsson et al., Int J Mol Sci. 2011 Jan. 21; 12 (1): 773-94, or combinations thereof.

In certain embodiments, the method further comprises high-resolution Raman mapping.

In certain embodiments, the method further comprises obtaining a MALDI spectrum of the sample. In particular embodiments, the method further comprises MALDI imaging.

In certain embodiments, the sample is snap frozen or heat treated.

In certain embodiments, the method further comprises embedding the sample in an embedding medium, matrix, or resin. In particular embodiments, the embedding medium comprises an M-1 embedding medium, an optimal cutting temperature (OCT) embedding medium, gelatin embedding medium, agar embedding medium, carboxymethyl cellulose (CMC) medium or ice. See, for example, Li et al., Sample preparation for mass spectrometry imaging of leaf tissues: a case study on analyte delocalization. Anal Bioanal Chem. 2018 November; 410 (28): 7449-7456.

In certain embodiments, the method further comprises cryo-sectioning the sample. In particular embodiments, the sample is cryo-sectioned onto a standard microscopy glass slide, an indium tin oxide (ITO)-coated slide or other conductive slides, including, but not limited to gold slides, aluminum oxide slides, steel plates, among others.

In certain embodiments, the method further comprises chemical derivatization of the sample.

In certain embodiments, the method comprises analyzing one or more intact proteins. In certain embodiments, the method further comprises analyzing one or more tryptic peptides. In certain embodiments, the method comprises analyzing one or more N-glycans, peptides, lipids, metabolites, drug molecules, and drug metabolites in a spatially resolved manner.

In certain embodiments, the sample is selected from an organ, a tissue, a cell, bacteria, fungi, a plant, a fruit, another lifeform, and an inanimate object.

In certain embodiments, a Raman signal of the sample with the one or more aromatic compounds deposited thereon is greater than a Raman signal of the sample without the one or more aromatic compounds deposited thereon.

Potential uses of the presently disclosed methods include, but are not limited to, a fee-for-service for diagnostic purposes, should there be biomarkers that can now be detected on biopsies or other samples that can now be readily identified with this technique; novel instrumentation, including combined RSI/MSI instrumentation, since both techniques are laser based; and a pre-coated slide or cover comprising one or more signal-enhancing aromatic compounds.

Following long-standing patent law convention, the terms “a,” “an,” and “the” refer to “one or more” when used in this application, including the claims. Thus, for example, reference to “a subject” includes a plurality of subjects, unless the context clearly is to the contrary (e.g., a plurality of subjects), and so forth.

Throughout this specification and the claims, the terms “comprise,” “comprises,” and “comprising” are used in a non-exclusive sense, except where the context requires otherwise. Likewise, the term “include” and its grammatical variants are intended to be non-limiting, such that recitation of items in a list is not to the exclusion of other like items that can be substituted or added to the listed items.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the presently disclosed subject matter. For example, the term “about,” when referring to a value can be meant to encompass variations of, in some embodiments, ±100% in some embodiments ±50%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

### EXAMPLES

The following Examples have been included to provide guidance to one of ordinary skill in the art for practicing representative embodiments of the presently disclosed subject matter. In light of the present disclosure and the general level of skill in the art, those of skill can appreciate that the following Examples are intended to be exemplary only and that numerous changes, modifications, and alterations can be employed without departing from the scope of the presently disclosed subject matter. The synthetic descriptions and specific examples that follow are only intended for the purposes of illustration and are not to be construed as limiting in any manner to make compounds of the disclosure by other methods.

### Example 1

Improved Raman Spectroscopy and Combined Raman-Matrix-Assisted Laser Desorption/Ionization (MALDI) Imaging Workflow with the Addition of Aromatic Compounds

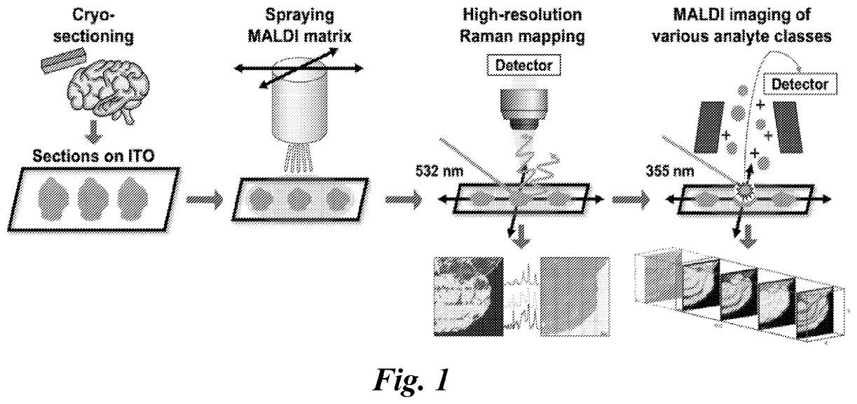

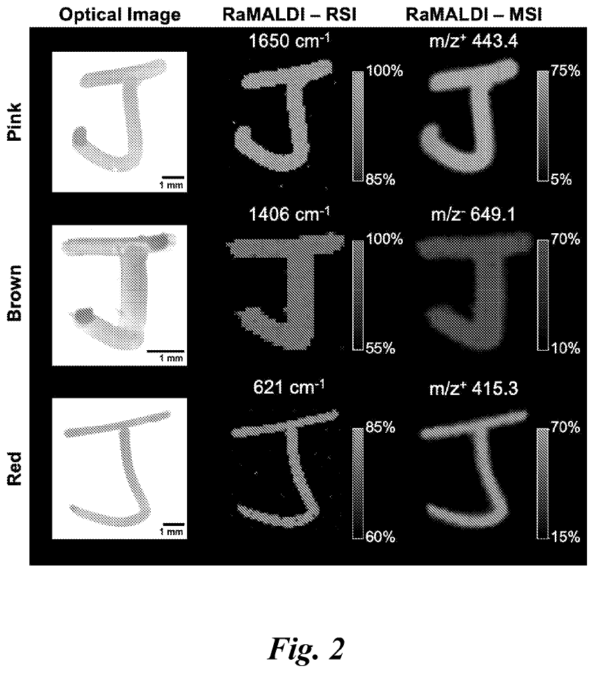

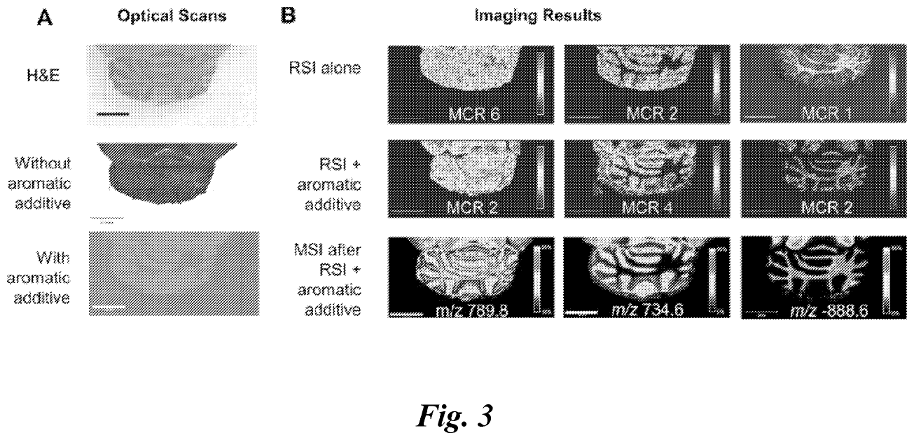

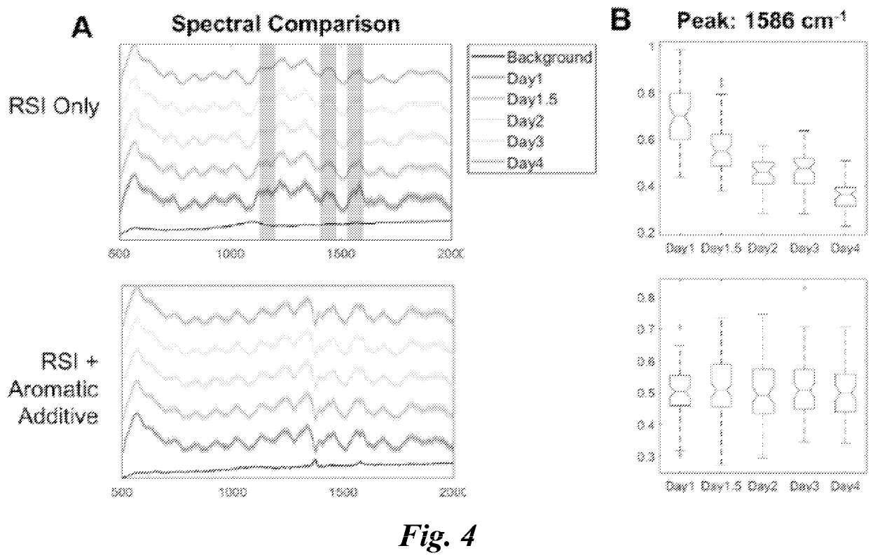

This example demonstrates the addition of an aromatic compound having an absorbance in the about 250-nm to about 500-nm range to the sample prior to analyzing the sample by Raman spectroscopy or RSI. This step reduces the overall Raman laser intensity necessary by up to 10-fold and overall acquisition time by three- to five-fold. It also eliminates the need to deposit additional MALDI matrix after RSI should a combined workflow be desired (FIG. 1). The feasibility of this technique is demonstrated on a biological (FIG. 2) and non-biological sample (FIG. 3), highlighting the compatibility of this new workflow and the derived benefits, particularly for RSI (FIG. 4).

### Example 2

### RaMALDI: Enabling Simultaneous Raman and MALDI Imaging of the Same Tissue Section

### 2.1 Overview

Multimodal tissue imaging techniques that integrate two complementary modalities are powerful discovery tools for unraveling biological processes and identifying biomarkers of disease. Combining Raman spectroscopic imaging (RSI) and matrix-assisted laser-desorption/ionization (MALDI) mass spectrometry imaging (MSI) to obtain fused images with the advantages of both modalities has the potential of providing spatially resolved, sensitive, and specific biomolecular information, but has so far involved two separate, consecutive tissue sections for RSI and MALDI MSI, resulting in images from two separate entities with inherent disparities. We have developed RaMALDI, a streamlined, integrated, multimodal imaging workflow of RSI and MALDI MSI, performed on a single tissue section with one sample preparation protocol. We show that RaMALDI imaging of various tissues effectively integrates molecular information acquired from both RSI and MALDI MSI of the same sample.

### 2.2 Background

Development of microscopic imaging technologies that probe the anatomical, functional, and molecular features of biological tissues has significantly contributed to biomedical research and clinical applications. However, single imaging modalities are inherently limited in application, whether it be by scope, scale, or sensitivity of the imaging technology, or the preparation and analysis requirements before and after the imaging procedure. Combining imaging techniques that complement one another extends their applications, allowing the investigation, assessment, and monitoring of increasingly diverse and complex biological systems. Bhargava et al., 2022. Multimodal imaging that combines the strengths of different modalities has emerged for a more comprehensive characterization of various diseases including cancers and their microenvironment. Masyuko and Lanni, 2013. Microscopic tissue images collected from different modalities have the potential to amplify and substantiate information by complementing each other. The use of multiple independent modalities helps to overcome the limitations inherent to individual sensors and reduce noise sources specific to a particular technology. However, while advanced multimodality imaging applications are currently expanding the scope of biomedical research, significant technical challenges still exist for combining certain technologies, including the integration of Raman spectroscopic imaging (RSI) and matrix-assisted laser-desorption/ionization (MALDI) mass spectrometry imaging (MSI).

Raman spectroscopy is widely used to identify biomolecular information in samples with chemical specificity. Kumamoto et al., 2018. Its label-free and non-destructive detection extends its applications to various biological samples including live cells, tissues, organs, and organisms. Paidi et al., 2017; Haka et al., 2016; Wróbel et al., 2021. Raman spectroscopy detects vibrational molecular information of a sample, allowing for quantitative analysis of lipids, nucleic acids, and proteins among other molecules. Wróbel et al., 2021; Talari et al., 2015; Rygula et al., 2013; Paidi et al., 2022; Czamara et al., 2015. RSI has the ability to resolve subcellular structures at submicron scales up to the diffraction limit of incident light, increasing its utility for studies that seek to understand the spatial distribution of these biomolecules in tissue samples. Opilik et al. 2013. However, RSI quality can be affected by fluorescence background from biomolecules or impurities of the sample. Wei et al., 2015. It also suffers from relatively poor sensitivity due to weak scattering efficiency, making imaging time rather long. Jones et al., 2019. For example, mapping 800×800 μm2 with a spatial resolution of 100 μm at an acquisition time of 0.5 sec will require about 2.3 minutes; however, if we desire an improved spatial resolution of 10 μm, then the acquisition time for RSI increases to almost 3.7 hours. This prolonged acquisition time could lead to sample degradation during the time of imaging.

MSI, on the other hand, provides a much greater level of sensitivity than RSI. Soft ionization techniques, such as MALDI MSI, are able to quantitatively detect and resolve tens to hundreds of m/z peaks in one experiment, each corresponding to a unique molecule. Cornett et al., 2007; Buchberger et al., 2018. Recent advances in laser technology and sample preparation techniques have enabled faster detection (mapping 800×800 μm2 at 100 μm spatial resolution requires about 8 seconds and at 10 μm spatial resolution about 7 minutes) of numerous classes of biologically relevant molecules at low micron resolution, ranging from small metabolites, Wang et al., 2015, and drugs, Castellino et al., 2011, to lipids, Chughtai et al., 2013; Jiang et al., 2015, gangliosides, Yang et al., 2019; Jackson et al., 2018, and glycans, Drake et al., 2017, Scupakova et al., 2021, making MALDI imaging an important tool in preclinical studies. Norris and Caprioli, 2013. While submicron MALDI imaging has been reported in the literature, Zavalin et al., 2012, the current state-of-the-art in MALDI matrix deposition and MSI instrumentation does not allow for spatial resolutions below 5 micron. Ščupáková et al., 2020; Gessel et al., 2014. Combining RSI and MALDI MSI in a multimodal imaging approach would considerably enhance the molecular specificity and spatial resolution of multiplexed, microscopic tissue imaging.

To achieve this goal, there have been a few studies on combining RSI and MALDI MSI to extract a condensed image with the advantages of both modalities. However, all previous studies involved two separate, consecutive tissue sections-one for RSI and the other one for MALDI MSI. Jadoul et al., 2014; Köhler et al., 2009. Moreover, some studies were limited to spectral comparisons. Jadoul et al., 2014; Köhler et al., 2009; Alessandri et al., 2016; Ali et al., 2020; Nešić et al., 2022. For producing correlated images, post-processing approaches were applied which required image conversion, Iakab et al., 2020, and extensive image registration. Bocklitz et al., 2013; Iakab et al., 2021. Although these studies reported some correspondence between RSI and MALDI MSI images collected from two consecutive sections, they were essentially limited by not being obtained from the same cells and tissues architectures across both methods, as each tissue section is separated from its adjacent sections by approximately 10 μm determined by the thickness of tissue sectioning. Neumann et al., 2020. RSI and MALDI MSI of the same sample using a single sample preparation method remains unexplored because of perceived compatibility issues between substrates and differences in sample preparation protocols. One recent study showed an integrated workflow with a surface-enhanced mode of MSI and RSI, which, however, requires a specialized nanostructured substrate for measurement. Iakab et al., 2022.

### 2.3 Scope

Here, we report the development of RaMALDI, a novel workflow that seamlessly integrates RSI and MALDI MSI of a single sample. Prior to our work, it was unclear whether this integration would be possible because of vastly different sample requirements for each technique. However, we hypothesized that a suitable substrate might facilitate the integration of the two techniques. After trials involving many matrix and sample preparation candidates, we identified a protocol that uniquely preserved both spectral and spatial qualities of integrated RSI and MALDI MSI. We applied the MALDI matrix 1,5-diaminonaphthalene (DAN) over a sample prepared on an indium-tin oxide (ITO) slide, a substrate typically disregarded in Raman spectroscopy due to spectral interference concerns. This finding led to the establishment of RaMALDI, facilitating multimodal imaging of RSI and MALDI MSI with considerably simplified sample preparation and minimal post-processing. We have demonstrated our approach across progressively complex samples, ranging from a nonbiological sample to liver homogenate, kidney, and brain tissue specimens. The resulting highly multiplexed multimodal images from RaMALDI imaging will allow us to better understand biological processes in a morphological and structural tissue context.

### 2.4 Results and Discussion

We developed RaMALDI, an integrated workflow of RSI and MALDI MSI as shown in FIG. 1. Our approach measures both RSI and MALDI MSI of a single sample. We tested and validated our new approach by using non-biological and several biological samples including liver, kidney, and brain as shown in the following.

### 2.4.1 RaMALDI Optimization

Optimization was necessary to run both RSI and MALDI MSI measurements on the same slide. Samples are usually prepared on quartz slides for RSI to minimize background (fluorescence and Raman) signal, while MSI frequently uses conductive slides, typically ITO slides, with various types of matrices sprayed on top of the tissue section. We tested and optimized the use of ITO slides with different MALDI matrices for RSI using drawings of Sharpie® permanent markers, which have high signal-to-noise ratio (SNR) for both RSI and MALDI MSI. We tested 9 different colors of Sharpie®—pink, brown, red, purple, orange, blue, green, black, and yellow—marked on an ITO slide. Among them, pink presented the clearest signal for both RSI and MSI (Table 1), thus we conducted optimization of the workflow with a pink Sharpie® marker.

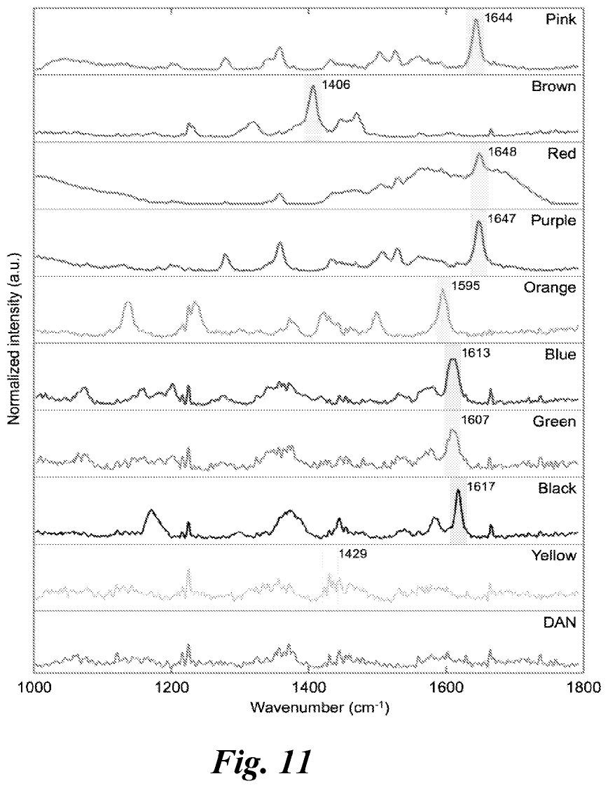

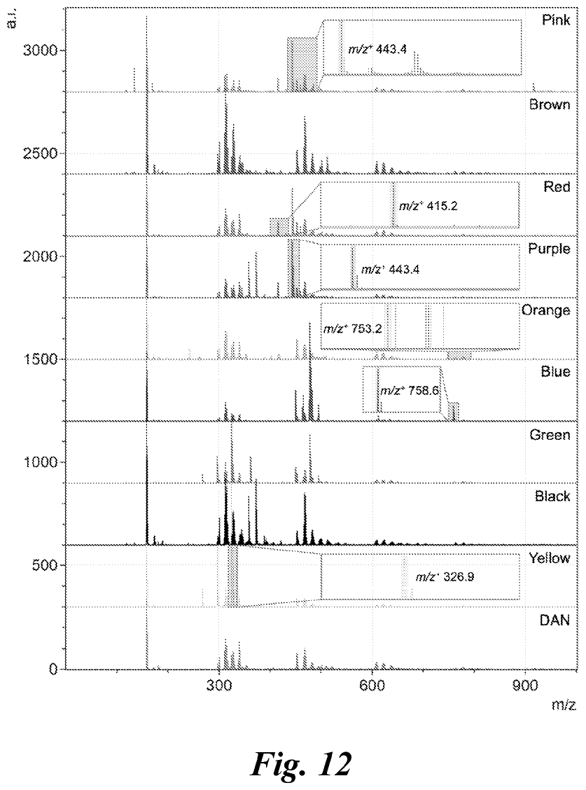

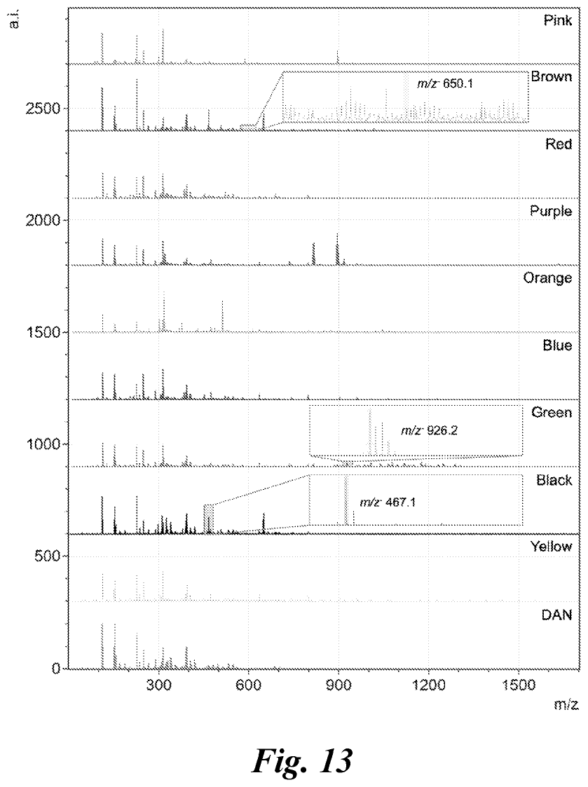

TABLE 1
Raman and MALDI signal scoring of Sharpie colors. The Raman and
MALDI MSI signals for the 9 Sharpie ® markers were
scored based on their overall signal intensity, where *****
represents the highest and * the lowest signal intensity and
image quality. An overall score was attributed to each color
based on their combined Raman and MALDI MSI ranking, where each
star represented 1 point, and ranked based on the highest to
lowest score. Based on this ranking, the pink Sharpie ® marker
represented the most suitable color for optimization given the
strong and clear signal from both Raman and MALDI MSI data.
The corresponding RSI and MALDI MSI spectra and imaging data
for this scoring are shown in FIG. 2, FIG. 11, FIG. 12, and FIG. 13.

| | |
|---|---|
| Raman | MALDI |

| Color | Final Score | Wavenumber | Pos | Neg |
|---|---|---|---|---|
| Pink | 12 | ***** | **** | *** |
| Brown | 11 | ***** | *** | *** |
| Red | 11 | **** | *** | **** |
| Purple | 11 | *** | **** | **** |
| Orange | 10 | *** | *** | **** |
| Blue | 9 | ** | *** | **** |
| Green | 9 | ** | ** | ***** |
| Black | 8 | *** | *** | ** |
| Yellow | 7 | * | *** | *** |

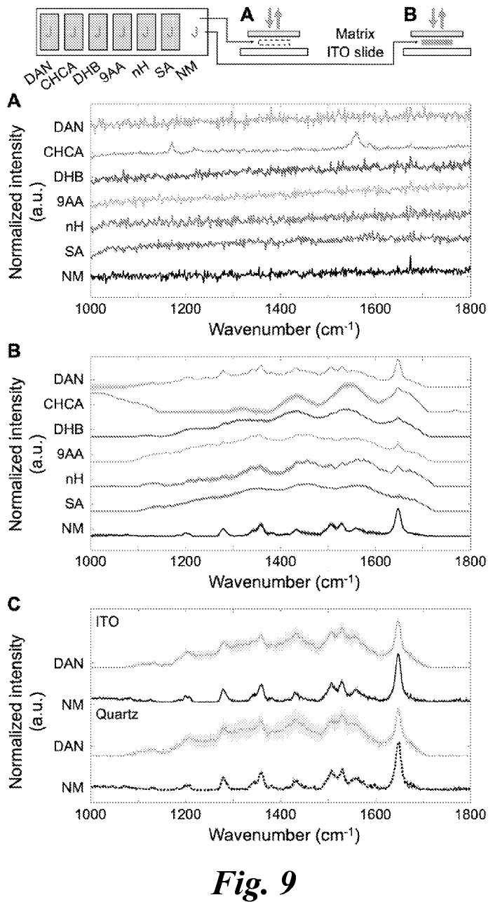

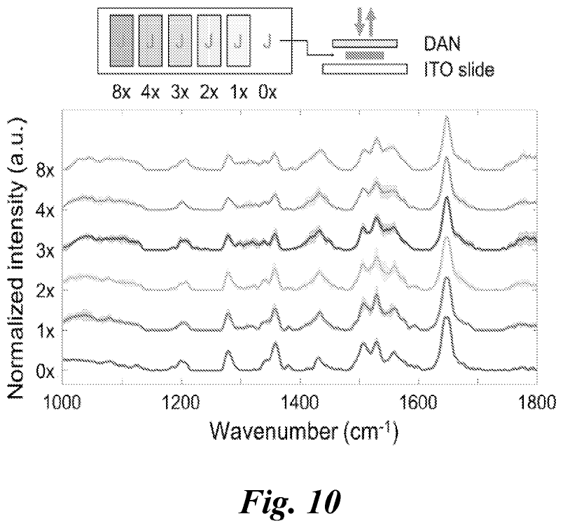

RaMALDI was optimized with two goals: (1) enabling both RSI and MSI measurements on a single sample; and (2) crucially, achieving minimal-to-no influence of RSI measurements on the quality of MSI measurements, which has presented a key challenge in employing both modalities on the same sample. For this purpose, we tested the potential suitability of various MALDI matrices based on the imaging performance. While spontaneous Raman spectroscopy typically does not require any foreign agents for measurement, matrix deposition is a necessary step for MALDI MSI to ionize molecules. We measured Raman spectra of pink Sharpie® marks on an ITO slide typically used for MALDI MSI, sprayed with the six most common MALDI matrices-1,5-diaminonapthalene (DAN), alpha-cyano-4-hydroxycinnamic (CHCA), 2,5-dihydroxybenzoic acid (DHB), 9-aminoacridine (9AA), norharmane (nH), and sinapinic acid (SA) (FIG. 9). Notably, Raman spectra acquired from DAN-sprayed pink Sharpie® marks on ITO slide showed almost no difference when compared to Raman spectra acquired from pink Sharpie® marks on ITO slide without matrix, or compared to Sharpie® marks on quartz slide, the latter of which is a standard setup for Raman measurements (FIG. 9C). Next, we examined if the matrix density of DAN deposition had any effect on the Raman spectra. Raman peaks of the pink Sharpie® marker were preserved regardless of DAN matrix density (FIG. 10). Based on these findings and since the optimal DAN matrix density for MALDI MSI of biological samples is 0.0016 mg/mm², we selected this same DAN density for subsequent RaMALDI measurements. All RaMALDI experiments were conducted with the optimized setup of sample prepared on an ITO slide, followed by spraying DAN at 0.0016 mg/mm² density over the sample, followed by RSI, and then MALDI MSI, as shown in the workflow in FIG. 1.

### 2.4.2 Non-biological Sample: Sharpie® Permanent Marker

We tested the RaMALDI imaging workflow with simple, nonbiological models of various Sharpie® permanent marker drawings in the shape of a “J”. RaMALDI was acquired from 9 different Sharpie® colors-pink, brown, red, purple, orange, blue, green, black, and yellow. While all colors clearly showed “J” markings with distinctive RSI and MALDI MSI peaks, pink, brown, and red Sharpie® markers showed the highest SNR for both the RSI and MALDI MSI portions of RaMALDI imaging (FIG. 2), which also agreed with the results of the RaMALDI optimization (Table 1). RaMALDI RSI images were mapped to the spatial distribution of baseline corrected, normalized Raman intensity based on the identified peaks unique to each color, which were 1650, 1406, and 621 cm⁻¹ for pink, brown, and red Sharpie® markers, respectively. The observed Raman peak at 1650 cm⁻¹ in the pink marker was attributed to C═C stretching vibration of the xanthene ring system of Rhodamine B, Braz et al., 2014, and Rhodamine 6G, Hildebrandt and Stockburger, 1984, and the quinoid ring system of quinacridone, Binant et al., 1990, which are commonly used for pink pigments. The characteristic peak at 1406 cm⁻¹ in brown likely resulted from carbon-based molecules, including quinacridone, Binant et al., 1990, azo compounds, Colombini and Kaifas, 2010, and isoindolinone. Ropret et al., 2008. In red, the peak at 621 cm⁻¹ was attributed to azo compounds, Vandenabeele et al., 2000, naphthol, Vandenabeele et al., 2000; Marcelino and Muralha, 2012, and phthalocyanine. Marcelino and Muralha, 2012. Similarly, RaMALDI MSI data were displayed at the corresponding m/z signals of m/z⁺443.4, m/z⁻ 649.1, and m/z⁺415.3, which were unique for pink, brown, and red Sharpie® markers, respectively. The observed peak at m/z⁺443.4 in pink marker and m/z⁺415.3 in red marker resulted from Rhodamine 6G and its derivatives. Gu et al., 2020; Soltzberg et al., 2007. The distinct peak at m/z 649.1 was likely caused by red dyes, such as direct red 28 and acid red 87 from the Schweppe collection. Soltzberg et al., 2007. Through peaks specific to each marker color as measured by RaMALDI RSI and MSI, we were able to identify Rhodamine B and Rhodamine 6G in pink marker, azo compounds in brown marker, and naphthol and Rhodamine 6G in red marker, which is consistent with previous studies using Raman and mass spectrometry-based identification of color pigments. Huynh et al., 2014. Along with the spectral domain, spatial images of both RaMALDI RSI and MSI clearly show the “J” markings with a uniform signal distribution and clear distinction from the background for each color-specific Raman and m/z peak. The corresponding spectra of all measured Sharpie® marker colors for both RSI and MALDI MSI are shown in FIG. 11-FIG. 12.

### 2.4.3 Biological Sample: Liver Tissue Homogenate

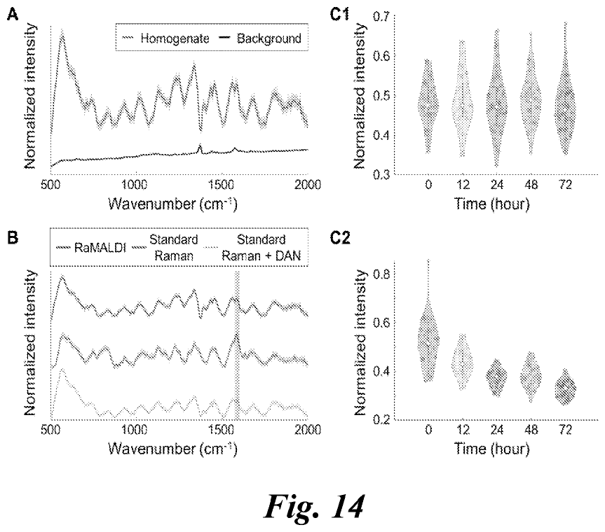

With the established workflow optimized using nonbiological samples, we tested RaMALDI using cryosections from tissue homogenates of mouse liver tissue. Liver tissue homogenate was selected because it provides characteristic tissue signals for a cross-section without characteristic morphological structures, as recently established in tissue mimetic model development for quantitative drug imaging using MALDI MSI. Barry et al., Bioanalysis 2019. We measured both Raman and MALDI mass spectra using the RaMALDI workflow with DAN matrix sprayed onto a liver tissue homogenate cryosection that was thaw-mounted onto an ITO slide (FIG. 14A). Both Raman and mass spectra showed the presence of various lipids in the sample. Using consecutive liver homogenate sections, we compared Raman spectra from the RaMALDI workflow to Raman spectra from standard Raman microspectroscopy, in which the consecutive liver homogenate section was placed on a separate quartz slide without DAN matrix (FIG. 14B). Identical lipid peaks were detected in Raman spectra from liver tissue homogenate sections measured in the RaMALDI workflow as compared to those measured with standard Raman spectroscopy, demonstrating the feasibility of the RaMALDI workflow for biological applications without compromising Raman signal integrity and quality.

Additionally, we discovered that spraying DAN matrix onto biological samples protects these samples from degradation (FIG. 14C). This was evident from observing the characteristic amide-II Raman peak at 1586 cm⁻¹ in liver tissue homogenate sections over time. While a decrease in the 1586 cm⁻¹ peak intensity was observed for a sample without DAN matrix sprayed onto the sample, the same peak remained at the initial intensity level when measuring a sample covered with DAN matrix for at least 72 hours, which was the duration of our longitudinal monitoring. This indicates that DAN matrix deposition onto biological tissue sections protects from direct exposure to the environment and laser-induced thermal and photodegradation during RSI measurements. Hence, this protective effect of DAN matrix for biological samples is beneficial for long-duration imaging tasks. For tissue imaging, especially at a high spatial resolution, RSI measurement can take several hours depending on the acquisition setup and mapping coverage, making it challenging to guarantee unaltered sample quality until MALDI MSI measurement is performed. This is a significant drawback in all previously reported studies for combining RSI and MALDI MSI on the same sample, which were all conducted in the order of RSI, matrix deposition, and MALDI MSI measurement. Bocklitz et al., 2013; Bocklitz et al., 2015; Ahlf et al., 2014.

### 2.4.4 Biological Sample: Kidney Tissue

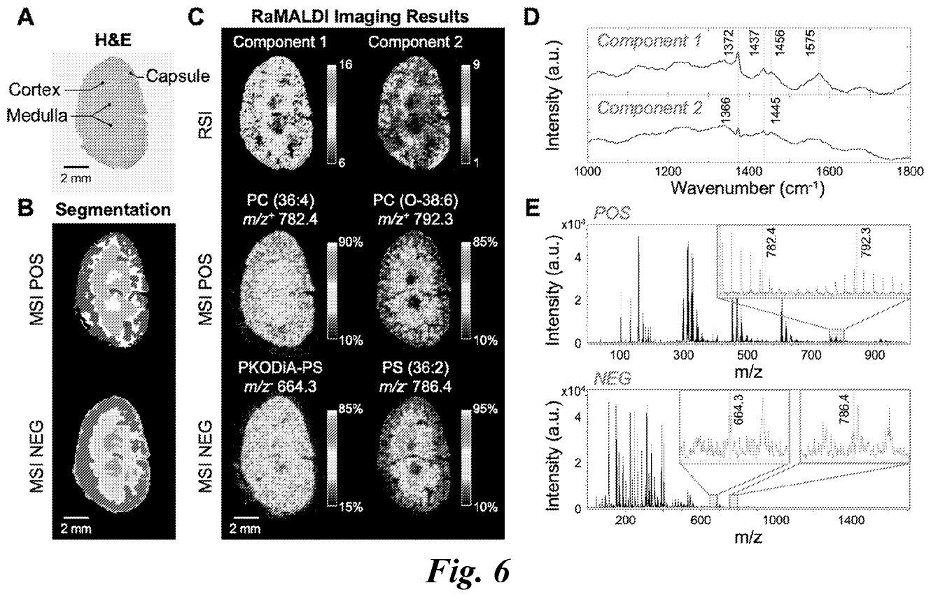

Moving into whole tissues, we tested the performance of RaMALDI imaging using tissue sections from fresh-frozen mouse kidneys. FIG. 6 shows Raman and MALDI MS images of the same kidney tissue section collected using the RaMALDI workflow, along with the corresponding hematoxylin and eosin (H&E) stained image (FIG. 6A) from the same section measured following RaMALDI imaging for identification of renal anatomical structures. In the top row of FIG. 6C, the RSI data of RaMALDI imaging of kidney tissue sections show the spatial distribution of two resolved chemical species. In particular, these represent the spatial distribution of components 1 and 2 identified using a spectral unmixing technique, termed multivariate curve resolution-alternating least squares (MCR-ALS). Detailed information regarding the generation of spatially resolved chemical images based on MCR-ALS modeling of Raman hyperspectral data is provided in the Supporting Information. FIG. 6D shows the resulting chemical spectra from MCR-ALS model-decomposed RaMALDI RSI data, including the Raman peaks that correspond to assignments listed in Table 2.

TABLE 2
Assignments for Raman peaks associated with
DNA/RNA and lipids of mouse kidney tissues.

| Raman | | |
|---|---|---|
| shift | Peak assignment | |
| (cm⁻¹) | Nucleic acids | Lipids |
| 1366 | | CH₃ symmetric stretch |
| | | (phospholipids) |
| 1372 | T, A, G (ring breathing modes | CH₃ stretching |
| | of the DNA/RNA bases) | |
| 1437 | | CH₂ Deformation |
| | | Lipids |
| 1445 | | CH₂ bending mode |
| | | of lipids |
| 1456 | Deoxyribose | |
| | Nucleic acid modes | |
| 1575 | Ring breathing modes in the DNA | |
| | base | |
| | Nucleic acid modes indicating the | |
| | nucleic acid content in tissues | |

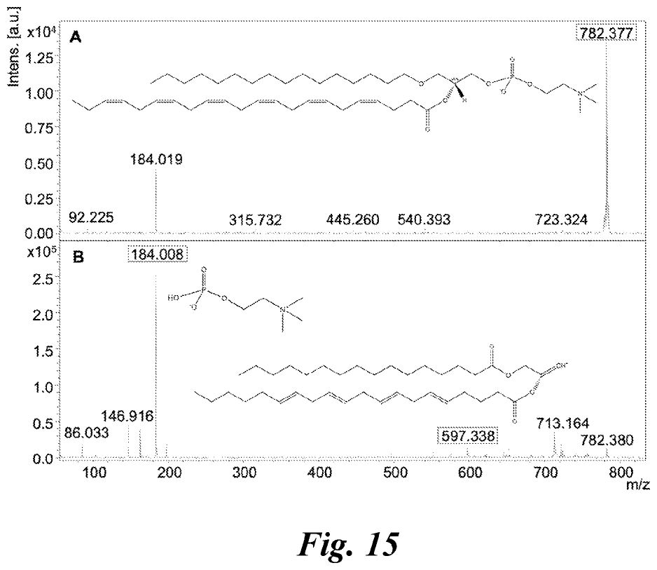

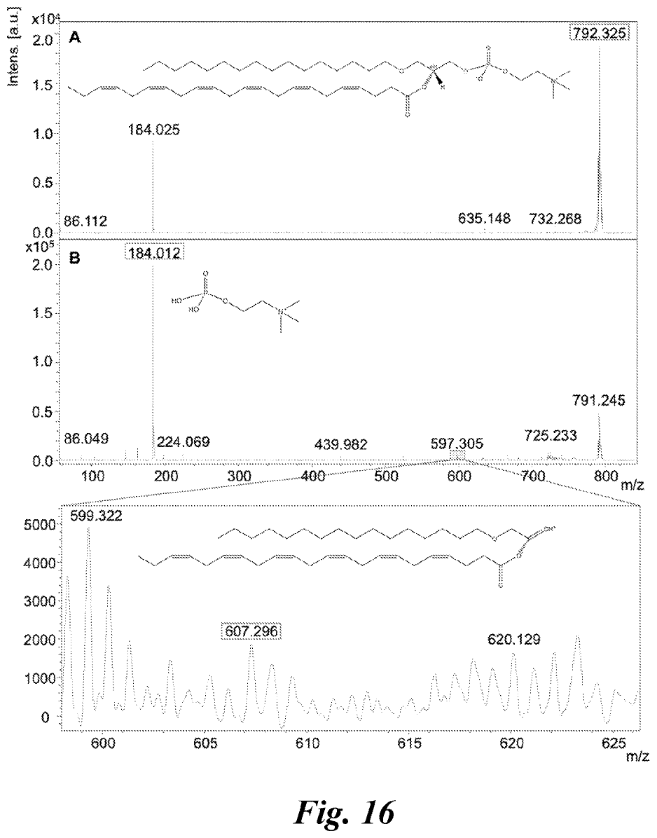

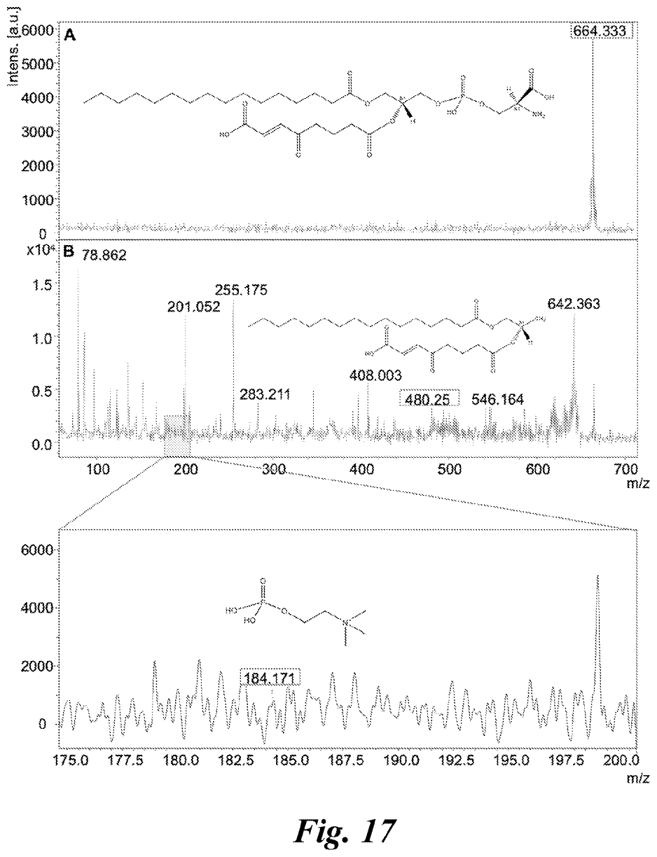

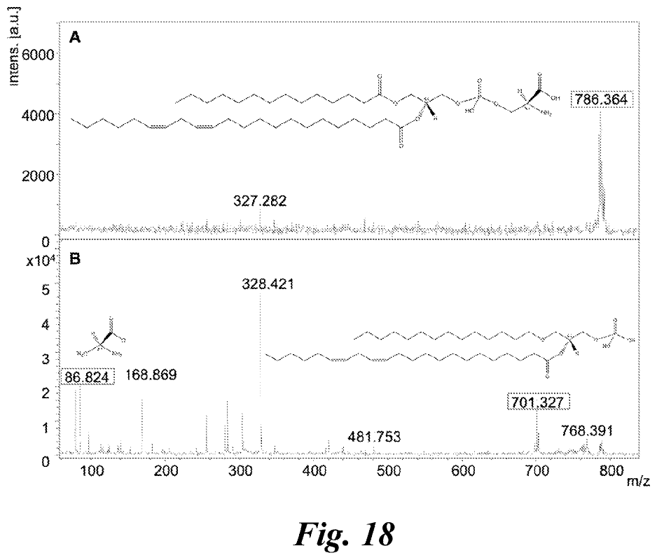

For component 1, Raman peaks at 1372, 1437, 1456, and 1575 cm⁻¹ were observed, which mostly resulted from nucleic acids. Talari et al., 2015. Also, the renal capsule was visualized on the chemical Raman map, which resulted from its high content of collagen and elastin in the fibrous extracellular matrix. Bulger, 1973. Raman peaks for component 2 included 1366, 1372, 1437, and 1445 cm⁻¹, which mainly arose from lipids. Talari et al., 2015. The identified Raman peaks are consistent with those reported in previous studies of the kidney under various conditions. Delrue and Speeckaert, 2022; Castiglione et al., 2018; Gulyamov et al., 2021; Dybas et al., 2016. While the MCR-ALS analysis of RSI images provides an important starting point for understanding the classes of compositional contributors and their spatial distribution, it does not offer definitive confirmation of the specific molecules in the tissue sample, making the integration with MALDI MSI particularly significant and insightful. The bottom two rows of FIG. 6C show both positive and negative ion images of RaMALDI MSI data at selected m/z peaks, which were identified as phosphatidylcholine (PC) (36:4), PC (O-38:6), 1-hexadecanoyl-2-(5-oxo-7-carboxy-6E-heptenoyl)-sn-glycero-3-phosphoserine (PKODiA-PS), and phosphatidylserine (PS) (36:2) using on-tissue MS/MS fragmentation for identification of the selected peaks as shown in FIG. 15-FIG. 18. FIG. 6E shows the corresponding whole tissue mass spectra of RaMALDI MSI data including the m/z signals displayed as MS images in FIG. 6C. RaMALDI RSI and MSI images from the same kidney tissue section showed clear spatial correspondence of anatomical structures including renal cortex, medulla and capsule, which were particularly apparent in the MSI segmentation images (FIG. 6B).

### 2.4.5 Biological Sample: Brain Tissue

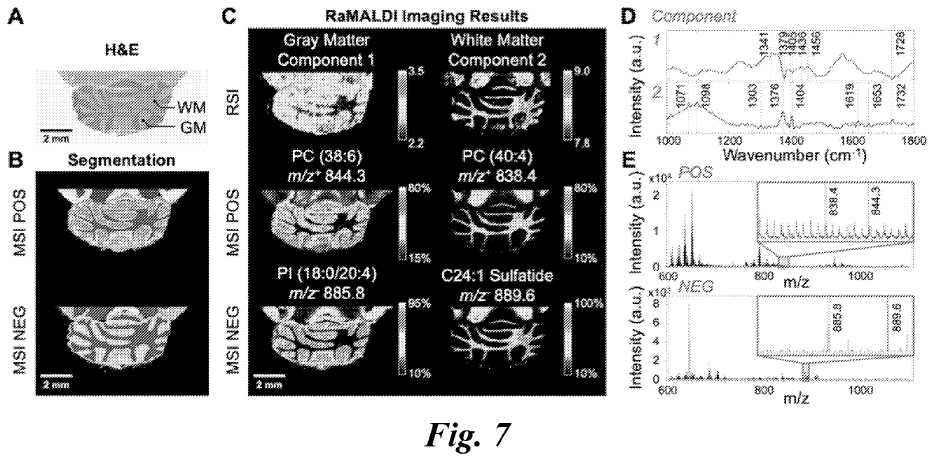

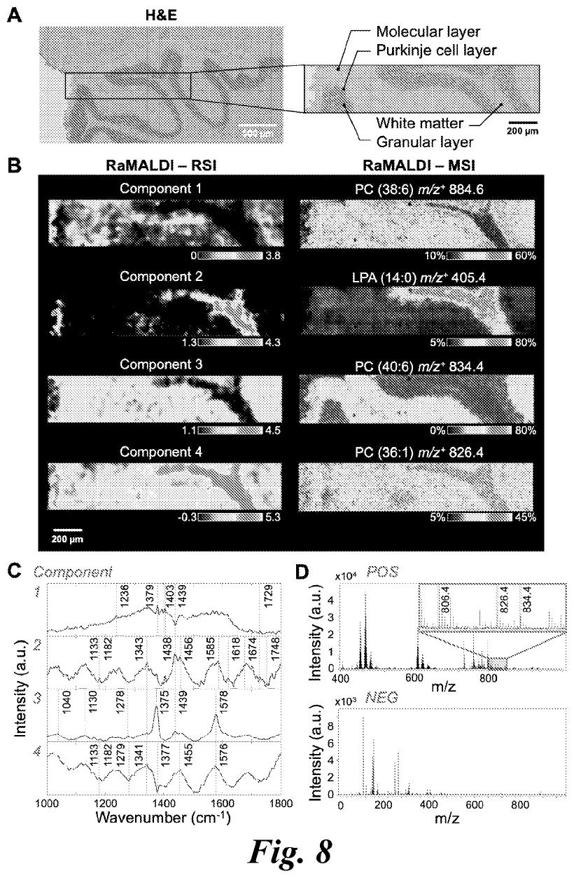

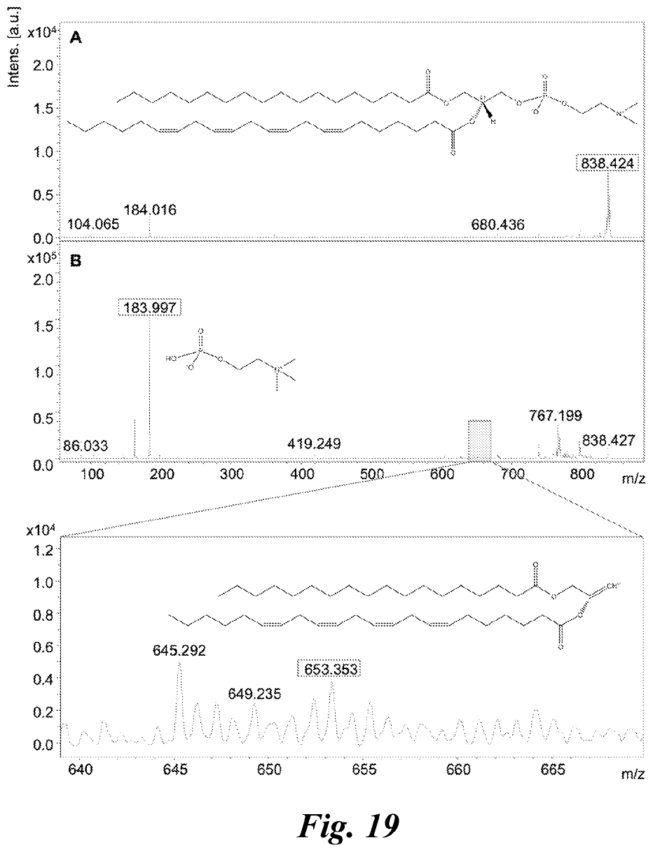

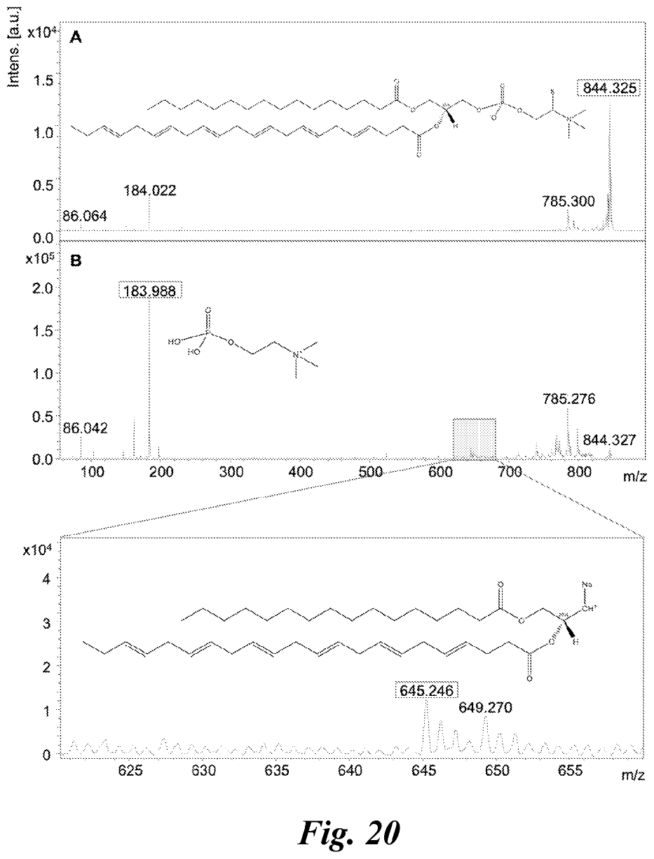

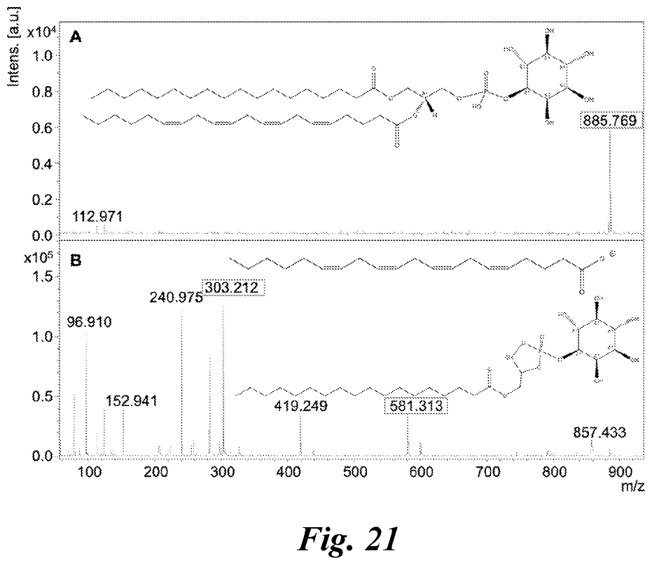

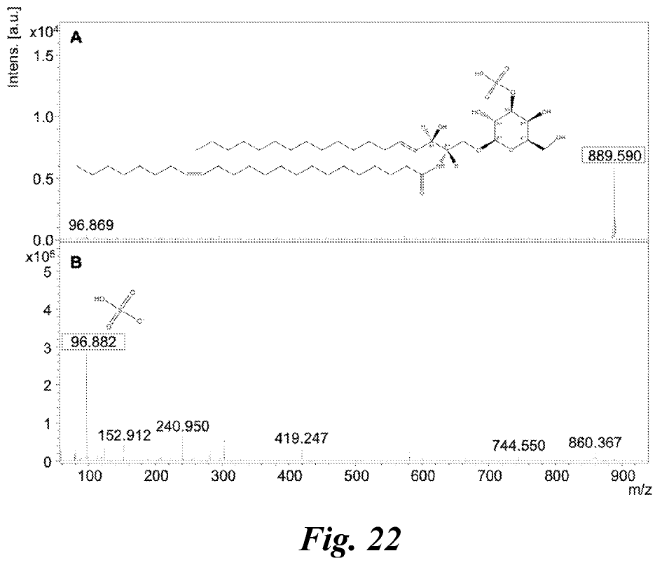

We further tested high spatial resolution RaMALDI imaging of fresh-frozen mouse brain sections. Since the cerebellum has a distinct anatomical and morphological structure with multiple molecular layers, we evaluated RaMALDI imaging for delineating this intricate structure. Brain tissue sections were imaged using the RaMALDI imaging workflow at spatial resolutions of 50 μm (FIG. 7) and 5 μm (FIG. 8) to evaluate the correspondence between RSI and MALDI MSI images regarding the fine histological features of the cerebellum. H&E-stained histological images were obtained from the same brain tissue section following RaMALDI imaging and are shown in FIG. 7A and FIG. 8A to identify distinct anatomical structures in the cerebellum. The gray and white matter were clearly distinguished in both RSI and MSI images of RaMALDI imaging as shown in FIG. 7C. The gray matter, which is mainly composed of myelinated axons of granule cells and dendrites of Purkinje cells, showed Raman peaks from both lipid and protein, identified in FIG. 7D and FIG. 8C. The white matter also displayed lipid and protein signatures from myelinated neuronal axons, and peaks associated with nucleic acids from cerebellar nuclei. These vibrational peaks were previously reported in studies of brain tissues with Raman microspectroscopy. Krafft et al., 2005; Heintz et al., 2021; Wesełucha-Birczyńska et al., 2016; Kochan et al., 2016. The bottom two rows of FIG. 7C display positive and negative ion modes of MALDI MSI images at selected, identified m/z peaks in FIG. 7C. Using on-tissue MS/MS fragmentation analysis of the selected peaks, as shown in FIG. 19-FIG. 22, we identified these lipids to be PC (38:6), PC (40:4), phosphatidylinositol (PI) (18: 0/20:4), and C24: 1 sulfatide (cis-tetracosenoyl sulfatide). C24: 1 sulfatide was reported in previous brain tissue MALDI MSI studies with a similar spatial distribution. Jackson et al., 2007.Previous studies, Jackson et al., 2005; Martinez-Gardeazabal et al., 2017, have also reported similar anatomical distributions of the detected PC (38:6) and PC (40:4) in white and gray matter while the exact physiological roles of these two PC species remain to be determined. The localization of the detected PI (18: 0/20:4) to gray matter suggests a possibly greater role in inter-neuronal signaling than that of other PI species. Lastly, sulfatides including C24: 1, are mostly found in white matter because they are a major component of the myelin that surrounds nerve fibers. Martinez-Gardeazabal et al., 2017.

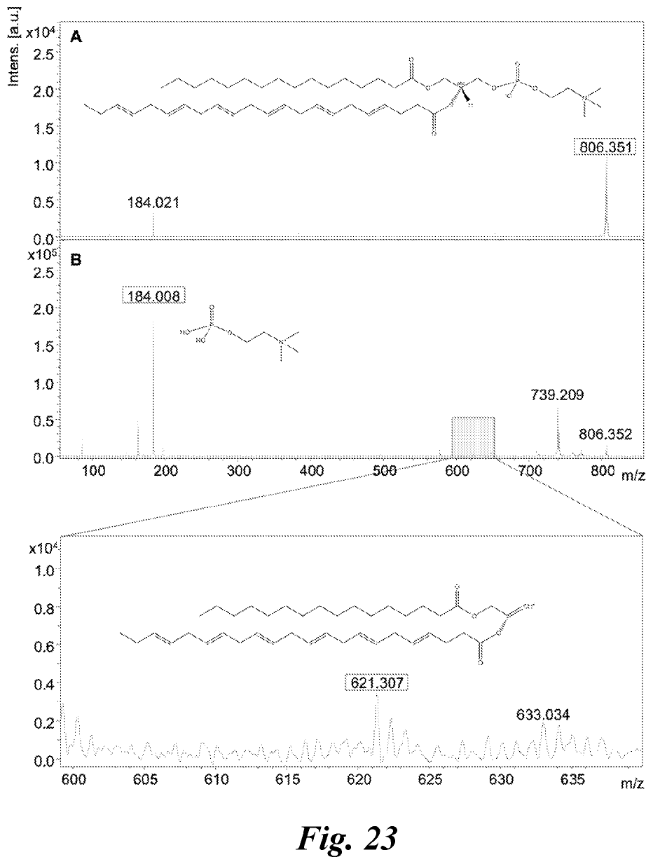

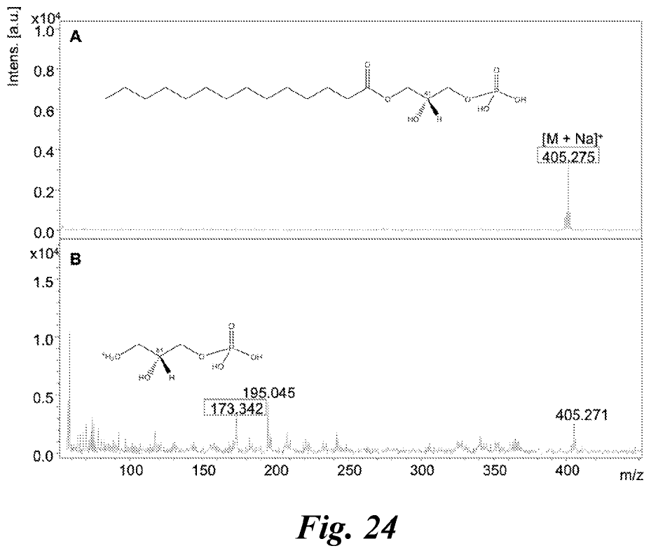

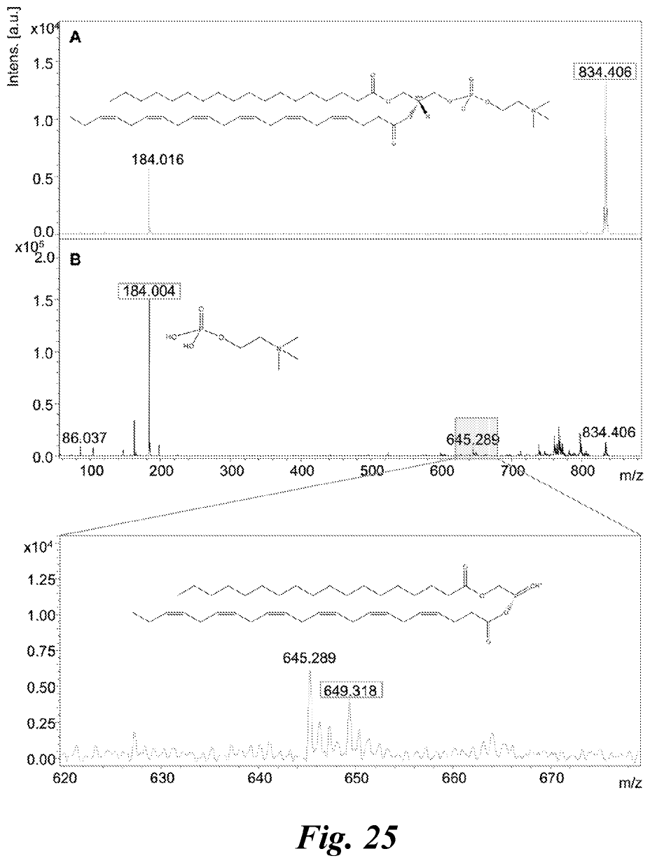

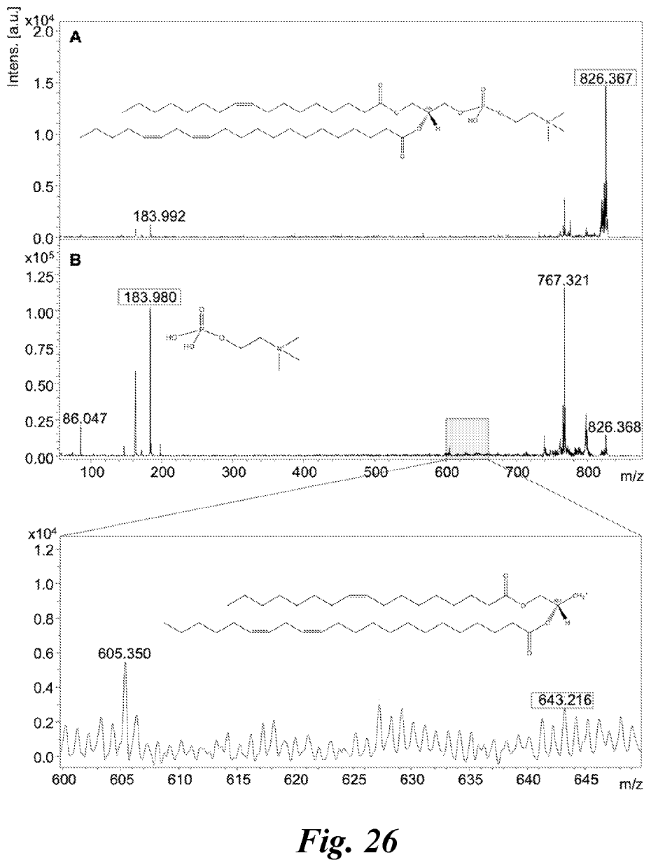

In the RaMALDI images of brain tissue sections acquired at 5 μm spatial resolution, the molecular distributions, particularly those of lipids, proteins, and nucleic acids, clearly show the molecular layers of the cerebellum. MCR-ALS resolved RSI images show relatively intense signals from components 1 and 3 in gray matter and from components 2 and 4 in white matter as shown in FIG. 8B with their respective spectra displayed in FIG. 8C. RSI spectra of all components in FIG. 7D and FIG. 8C show mixed features of nucleic acids, lipids, and proteins. As white matter has a relatively high lipid content, peaks at 1133, 1438, and 1674 cm⁻¹, associated with C—C stretch, CH₂ deformation, and C═C stretch vibrations of lipids were observed in components 2 and 4. Component 2 displayed cholesterol peaks at 1133, 1438, and 1674 cm⁻¹, which was previously shown to be one of the most abundant lipids in the brain. Krafft et al., 2005. Also, both components 3 and 4 featured overall signal from the outer molecular layer surrounding the cerebellum. Peaks contributed by protein content in brain tissues were observed in amide I, II, and III bands ranging between 1600-1700, 1480-1575, and 1200-1300 cm⁻¹, respectively. All observed RSI peaks of brain tissues and their molecular assignments are summarized in Table 3. The right column of FIG. 8B shows positive ion mode MSI images at selected, identified m/z peaks, whose spectral domain is shown in FIG. 8E. Using on-tissue MS/MS fragmentation analysis of these selected peaks, we identified these lipids to be PC (38:6), lysophosphatidic acid (LPA) (14:0), PC (40:6), and PC (36:1) as shown in FIG. 23-FIG. 26. Previous studies have reported similar anatomical distributions of these three PCs in gray and white matter, Jackson et al., 2005; Martinez-Gardeazabal et al., 2017, with PC (38:6) localizing to molecular, Purkinje cell, and granular layers, PC (40:6) enriched in the molecular layer, and PC (36:1) detected predominantly in white matter. The detected LPA (14:0) is primarily localized to white matter, suggesting its possible roles in neural activities specific to this region of the cerebellum.

TABLE 3
Assignments for Raman peaks associated with DNA/RNA,
lipids, and proteins of mouse brain tissues.

| Raman | Peak assignment | | |
|---|---|---|---|
| shift | Nucleic | | |
| (cm⁻¹) | acids | Lipids | Proteins |
| 1040 | | | Phenylalanine |
| 1071, 1098 | | C—C stretch of | |
| | | triacylglycerols | |
| 1130, 1133 | | C—C stretch of | C—N stretch |
| | | cholesterol and | |
| | | cholesterol esters | |
| 1182 | Cytosine, | C—C stretch of lipid | |
| | guanine, | | |
| | adenine | | |
| 1200-1300 | | | Amide III |
| 1303 | | CH3, CH2 twisting | |
| | | and torsion of lipid | |
| 1341, 1343 | A or G of | CH3, CH2 wagging | |
| | DNA | (collagen assignment) | |
| 1375 | T, A, G | | |
| | (ring | | |
| | breathing | | |
| | modes of | | |
| | the | | |
| | DNA/RNA | | |
| | bases) | | |
| 1404 | | | CH deformation |
| 1436, | | CH2 deformation, | |
| 1438, 1439 | | lipid, cholesterol | |
| 1455, 1456 | | CH3, CH2 bending | C—H deformation |
| | | of triacylglycerol | |
| 1480-1575 | | | Amide II |
| 1576, 1578 | Nucleic | | |
| | acid mode, | | |
| | guanine, | | |
| | adenine | | |
| 1585 | | | Phenylalanine, |
| | | | hydroxyproline |
| 1600-1700 | | | Amide I |
| 1618, 1619 | | | Tyr, Trp, Phe |
| 1653 | | C═C stretch of | |
| | | fatty acid | |
| 1674 | | C═C stretch of | |
| | | cholesterol and | |
| | | cholesterol esters | |
| 1729, 1748 | | C═O stretch of | |
| | | triacylglycerol | |

In summary, RaMALDI imaging is a new, streamlined workflow for acquiring highly multiplexed molecular tissue images by performing RSI and MALDI MSI on the same tissue sample. This approach allows for multimodality imaging to characterize molecular features within their respective morphological-anatomical tissue structures. The presented workflow is a crucial step towards rapid, simple multimodal tissue imaging that can be applied in studies aimed at biomedical discovery of clinically relevant biomarkers. While our rationally designed proof-of-principle study has focused on the MALDI matrix DAN, which was based on our discoveries of the lack of RSI signals from DAN and its protection against tissue degradation, future follow-up studies could further explore other MALDI matrices and additional types of tissue samples in healthy and various pathological states.

### 2.5 Experimental Procedures

### 2.5.1 Sample Preparation

### 2.5.1.1 Solvents and Chemicals

Unless otherwise noted, all solvents and trifluoroacetic acid (TFA) were purchased from Sigma Aldrich (St. Louis, MO). 1,5-Diaminonapthalene (DAN), α-cyano-4-hydroxycinnamic acid (CHCA), 2,5-dihydroxybenzoic acid (DHB), norharmane (nH), 9-aminoacridine (9AA) and sinapic acid (SA) MALDI matrices were purchased from Sigma Aldrich (St. Louis, MO). Solvents were all MS grades.

### 2.5.1.2 Sample Preparation

For each RaMALDI imaging experiment, specimens were prepared on indium tin oxide (ITO)-coated glass slides (Delta Technologies, Loveland, CO) and used for both Raman spectroscopy and MALDI MSI measurements. The standard approach for Raman spectroscopy was used for comparison, which was to place specimens on quartz slides to minimize spectral interference from slide background. We utilized both nonbiological (“J” drawings of Sharpie® permanent markers) and biological (mouse liver, kidney, and brain tissue) samples for the optimization and testing of the RaMALDI imaging workflow.

### 2.5.1.2.1 Matrix Deposition

For matrix deposition, 50 mM solutions of each matrix in 1:1 ACN: H2O+0.1% TFA were sprayed onto the sample with an HTX M5 Sprayer (HTX Imaging, Chapel Hill, NC) using the following parameters: 4 passes, 100 μL/min flow rate, 1200 mm/min nozzle/track velocity, 3 mm track spacing, 30° C. nozzle temperature, criss cross pattern, and 0 s dry time. For matrix density optimization, all parameters were kept constant, except for the number of passes, which varied from 0 to 8 passes to achieve 0, 0.0004, 0.0008, 0.0012, 0.0016, and 0.0032 mg/mm² of matrix density.

### 2.5.1.2.2 Nonbiological Samples

For Sharpie® drawings, 9 different colors-pink, brown, red, purple, orange, blue, green, black, and yellow-were used. We wrote “J” with a size of approximately 5 mm by 5 mm onto ITO slides, onto which we then sprayed the matrix of choice.

### 2.5.1.2.3 Biological Samples

All animal experiments were approved by the Institutional Animal Care and Use Committee (IACUC) of the Johns Hopkins University School of Medicine, which is fully accredited by the American Association for the Accreditation of Laboratory Animal Care (AAALAC). Adult athymic nude nu/nu mice (Taconic Biosciences, Rensselaer, NY) of about three months of age were sacrificed, and their kidneys, livers, and brains were frozen in liquid nitrogen vapors. These frozen organs were stored at −80° C. until use.

### 2.5.1.2.4 Homogenized Liver Samples

Liver homogenates were prepared by using four to five livers, which were ground on liquid nitrogen, and 300 mg of tissue were weighed into Precellys bead homogenizer tubes (VWR, Radnor, Pennsylvania, USA) and homogenized using a Bertin Precellys Evolution Homogenizer (Bertin Corp, Rockville, MD) with the following parameters: 2 mL, 6800 RPM, 4×30 seconds cycle with 45 seconds pauses. These samples were centrifuged in an Eppendorf 5424R Centrifuge (Eppendorf, Hamburg, Germany) for 1 min at 15000 rpm and frozen into plugs using a home-built silicone mold in liquid nitrogen vapors prior to storage at −80° C. until cryo-sectioning was performed.

### 2.5.1.2.5 Cryo-Sectioning

All biological samples including mouse liver homogenates, kidneys, and brains were cryo-sectioned using a Leica CM1860 UV cryostat (Leica Biosystems, Wetzlar, Germany) at 10 μm thickness and thaw-mounted onto ITO slides, followed by spraying of the matrix of choice as described hereinabove. Mouse kidneys were sectioned coronally, and mouse brains horizontally.

### 2.5.1.2.6 Histology

For kidney and brain tissue sections, MALDI matrix was washed off following RaMALDI experiments using ethanol for 24 hours, followed by hematoxylin and eosin (H&E) staining conducted on the same tissue section using a standard protocol with Mayer's hematoxylin solution and aqueous Eosin Y solution from Sigma Aldrich (St. Louis, MO). H&E-stained slides were imaged at 40× magnification using a NanoZoomer S210 Digital slide scanner (Hamamatsu Photonics, Shizuoka, Japan). The H&E-stained tissue sections were visualized and exported from Aperio ImageScope (v 12.4.6, Leica Biosystems, Deer Park, IL).

### 2.5.2 Data Acquisition

### 2.5.2.1 Raman Spectroscopy and RSI

Raman spectra of all samples were measured using an XploRA PLUS confocal Raman microspectroscopy (Horiba Jobin-Yvon, Villeneuve-d'Ascq, France) equipped with a 532 nm diode laser for excitation. Raman scattering resulting from light-sample interactions was collected through an objective lens, dispersed with a diffraction grating density of 1800 gr/mm, and recorded by a thermoelectrically cooled CCD camera that was coupled to the microscope.

Experimental parameters varied for each sample. Sharpie® markers were raster-scanned with 1% laser power for 0.5s acquisition time for each data point and collected with a 5× objective lens (FIG. 2, FIG. 9). Kidney tissue sections used 10% laser power for 1s per acquisition point. Raman mapping of kidney tissue (FIG. 6), also collected with a 5× objective lens, covered 9×6.4 mm², with a spatial resolution of 100 μm. For mouse brain tissue sections, the larger map with a coverage of 4.4×8 mm² (FIG. 7) was raster-scanned at 50 μm spatial resolution with 10% laser power for 0.1s using a 10× objective lens. The mouse brain tissue section acquired with a smaller field of view (FIG. 8) was collected at 5 μm spatial resolution with 1% laser power for 0.5s using a 100× objective lens. The Raman spectrum at each acquisition point was obtained by averaging three repetitions for all samples.

### 2.5.2.2 MALDI MSI

All MALDI MSI experiments were conducted using a rapifleX MALDI TOF/TOF system (Bruker Daltonics, Billerica, MA) equipped with a 10 kHz smartbeam 3D Nd: YAG laser at 355 nm. flexControl (v 4.0) was used to control the instrument and optimize the acquisition parameters, while flexImaging (v 5.0) was used to set up the MALDI imaging experiments and select the regions of interest. The extraction voltage was set to −20 kV, lens voltage of −11.3 kV, reflectron voltages at −20.86 kV, −1.085 kV and −8.6 kV, with a delay time of 100 ns, while the laser fluence was optimized for each matrix. Prior to data acquisition, height adjustment (target profile generation), laser focus tuning, and external mass calibration with red phosphorus were conducted to achieve a mass error <5 PPM.

For Sharpie® drawings (FIG. 2), data were acquired in either positive or negative ion reflectron mode at 200 laser shots per pixel with a raster width of 100 μm in m/z 200-1000 in beam scan mode. For biological tissues, data were acquired using dual polarity. Kidney tissue sections (FIG. 6) were imaged using a 100 μm raster width with dual polarity of negative mode from m/z 0-1000 followed by positive ion mode from m/z 0-1700, using the protocol in, Kaya et al., 2018, without any offset. To achieve this, 50 laser shots were acquired in both modes with beam scan on. Brain tissue sections (FIG. 7) were imaged at 50 μm raster width with dual polarity of negative ion mode from m/z 0-1000 followed by positive ion mode from m/z 0-1700, using the protocol in, Kaya et al., 2018, without any offset, again with 50 laser shots acquired in both modes with beam scan on. For high spatial resolution MSI (FIG. 8), brain tissue sections were imaged using a 5 μm raster width with positive ion mode only from m/z 400-1000 on the cerebellum. Regions of interest (ROIs) containing areas previously sampled by RSI and without were acquired for comparison. To achieve this, the scanned image was rescaled in ImageJ to 10160 dpi to obtain 2.5 um pixel size and reduce chances of striping. Further, laser shots were optimized to 50 and data acquired with beam scan off to achieve a laser beam size of ≤5 μm. MS/MS was conducted with the LIFT unit of the rapifleX TOF/TOF system with argon as a collision gas with an isolation window of +1 m/z at 60% laser power boost and 4000 laser shots for fragmentation

### 2.5.3 Data Analysis

### 2.5.3.1 Raman Spectroscopy and RSI Data Processing and Analysis

All Raman data were subjected to pre-processing, including noise reduction, and sbaseline correction followed by normalization. Butler et al., 2016. The collected Raman spectra were first denoised with cosmic ray removal and Savitzky-Golay filters to remove the noise while preserving spectral features. Schafer, 2011. The denoised spectra were corrected with a best-fit polynomial-based fluorescence background removal. The spectra were then min-max normalized to correct potential experimental variations. For analysis, the pre-processed Raman spectra were trimmed to biological fingerprint wavenumber region (1,000-1,800 cm⁻¹). Kidney and brain tissue spectra were further analyzed with multivariate curve resolution-alternating least squares (MCR-ALS) algorithm to identify constituent compounds in the tissue samples without a priori information of their composition. Jaumot et al., 2015. The MCR-ALS algorithm processed complex Raman spectra at each acquisition point by decomposing unresolved mixtures into pure individual components with respect to their relative concentration. The unmixing of spectra was based on the number of Raman signatures, estimated by singular value decomposition (SVD), to minimize subjectivity of decomposition procedure. The recovery of pure Raman profiles was achieved as MCR-ALS reached convergence through an iterative optimization under the non-negativity constraint on spectra and relative concentration. All Raman spectral data were processed and analyzed by using MATLAB R2021b (Math Works, Natick, MA).

### 2.5.3.2 MALDI MSI Data Processing and Analysis

The MALDI MSI data processing varied based on sample type. For nonbiological samples, MALDI MSI data were directly exported from flexImaging (v 5.0, Bruker Daltonics) with total ion current (TIC) normalization. Average spectra for each Sharpie® marker were exported from flexImaging and imported into mMass for comparison. Niedermeyer and Strohalm, 2012. For biological samples, MALDI MSI data were imported into SCILS Lab (v 2021b, Bruker Daltonics) and segmentation analysis was conducted on TIC normalized data through the software's segmentation pipeline, which conducts peak picking and peak alignment and smoothing prior to segmentation using the bisecting k-means in combination with correlation distance. Segmentation maps were generated and exported from SCiLS Lab. Individual representative m/z features from each segment were identified from the segmentation analysis and the corresponding results were then visualized in flexImaging.

### 2.6 Summary

We have developed RaMALDI imaging, an integrated workflow of RSI and MALDI MSI conducted on a single sample with a one-step sample preparation method. RaMALDI imaging is advantageous because it allows for analysis of a single tissue section with both modalities, which reduces the amount of sample needed, and significantly streamlines the multimodal approach, ultimately enabling highly multiplexed molecular imaging discoveries in tissue- and cell-based biomedical research.

We have demonstrated RaMALDI imaging applications of nonbiological and biological samples using Sharpie® marker drawings, cryosections of mouse liver tissue homogenates, mouse kidneys, and mouse brains. We were able to collect spectral and spatial information of an identical tissue section in a robust and reliable manner, without compromising the quality of either. The RaMALDI imaging approach, which measured a single tissue section by consecutive RSI followed by MSI, generated highly multiplexed molecular maps of mouse brain tissue with a lateral spatial resolution of down to 5 μm for both modalities.

The RaMALDI workflow offers a significantly simplified data processing and analysis approach, which facilitates effective interpretation of the two multimodal images. Our workflow does not require extensive post-acquisition image registration between RSI and MSI images for analysis, as RaMALDI images are collected from an identical sample prepared in an identical manner, making them inherently registered. Enabling multimodal imaging of a single tissue section significantly simplifies the sample preparation procedure and avoids potential challenges with morphological discrepancies arising from either intentional or unintentional variations in sample preparation protocols. Such morphological variance between two separate, consecutive tissue sections prepared for two different imaging modalities often prolongs the analysis procedure and hampers comprehensive molecular interpretation of the imaged tissue. Lastly, we observed that matrix application onto tissue sections is advantageous as it protects from degradation, thereby enabling longer imaging times.

By demonstrating that RaMALDI imaging is feasible, we have effectively established the feasibility of simultaneous Raman and MALDI imaging of the same tissue section, which will become possible once instrumentation for Raman spectroscopy and MALDI imaging has been integrated.

### REFERENCES

All publications, patent applications, patents, and other references mentioned in the specification are indicative of the level of those skilled in the art to which the presently disclosed subject matter pertains. All publications, patent applications, patents, and other references are herein incorporated by reference to the same extent as if each individual publication, patent application, patent, and other reference was specifically and individually indicated to be incorporated by reference. It will be understood that, although a number of patent applications, patents, and other references are referred to herein, such reference does not constitute an admission that any of these documents forms part of the common general knowledge in the art.
A. Bhargava, B. Monteagudo, P. Kushwaha, J. Senarathna, Y. Ren, R. C. Riddle, M. Aggarwal, A. P. Pathak, Nature Methods 2022, 19, 242-254.
R. Masyuko, E. J. Lanni, J. V. Sweedler, P. W. Bohn, Analyst 2013, 138, 1924-1939.
Y. Kumamoto, Y. Harada, T. Takamatsu, H. Tanaka, Acta histochemica et cytochemica 2018, 51, 101-110.
S. K. Paidi, A. Rizwan, C. Zheng, M. Cheng, K. Glunde, I. Barman, Cancer research 2017, 77, 247-256.
A. S. Haka, E. Sue, C. Zhang, P. Bhardwaj, J. Sterling, C. Carpenter, M. Leonard, M. Manzoor, J. Walker, J. O. Aleman, Analytical chemistry 2016, 88, 2140-2148.
M. S. Wróbel, J. H. Kim, P. Raj, I. Barman, J. Smulko, Biosensors and Bioelectronics 2021, 180, 113115.
A. C. S. Talari, Z. Movasaghi, S. Rehman, I. U. Rehman, Applied spectroscopy reviews 2015, 50, 46-111.
A. Rygula, K. Majzner, K. M. Marzec, A. Kaczor, M. Pilarczyk, M. Baranska, Journal of Raman Spectroscopy 2013, 44, 1061-1076.
S. K. Paidi, J. R. Troncoso, M. G. Harper, Z. Liu, K. G. Nguyen, S. Ravindranathan, L. Rebello, D. E. Lee, J. D. Ivers, D. A. Zaharoff, N. Rajaram, I. Barman, Theranostics 2022, 12, 5351-5363.
K. Czamara, K. Majzner, M. Z. Pacia, K. Kochan, A. Kaczor, M. Baranska, Journal of Raman Spectroscopy 2015, 46, 4-20.
L. Opilik, T. Schmid, R. Zenobi, Annual Review of Analytical Chemistry 2013, 6, 379-398.
D. Wei, S. Chen, Q. Liu, Applied Spectroscopy Reviews 2015, 50, 387-406.
R. R. Jones, D. C. Hooper, L. Zhang, D. Wolverson, V. K. Valev, Nanoscale research letters 2019, 14, 1-34.
D. S. Cornett, M. L. Reyzer, P. Chaurand, R. M. Caprioli, Nature Methods 2007, 4, 828-833.
A. R. Buchberger, K. DeLaney, J. Johnson, L. Li, Anal Chem 2018, 90, 240-265.
J. Wang, S. Qiu, S. Chen, C. Xiong, H. Liu, J. Wang, N. Zhang, J. Hou, Q. He, Z. Nie, Analytical Chemistry 2015, 87, 422-430.
S. Castellino, M. R. Groseclose, D. Wagner, Bioanalysis 2011, 3, 2427-2441.
K. Chughtai, L. Jiang, T. R. Greenwood, K. Glunde, R. M. Heeren, J Lipid Res 2013, 54, 333-344.
L. Jiang, K. Chughtai, S. O. Purvine, Z. M. Bhujwalla, V. Raman, L. Pasa-Tolic, R. M. A. Heeren, K. Glunde, Anal Chem 2015, 87, 5947-5956.
E. Yang, M. Dufresne, P. Chaurand, International Journal of Mass Spectrometry 2019, 437, 3-9.
S. N. Jackson, L. Muller, A. Roux, B. Oktem, E. Moskovets, V. M. Doroshenko, A. S. Woods, J Am Soc Mass Spectrom 2018, 29, 1463-1472.
R. R. Drake, T. W. Powers, E. E. Jones, E. Bruner, A. S. Mehta, P. M. Angel, Adv Cancer Res 2017, 134, 85-116.
K. Scupakova, O. T. Adelaja, B. Balluff, V. Ayyappan, C. M. Tressler, N. M. Jenkinson, B. S. Clacs, A. P. Bowman, A. M. Cimino-Mathews, M. J. White, P. Argani, R. M. Heeren, K. Glunde, JCI Insight 2021, 6.
J. L. Norris, R. M. Caprioli, Chemical Reviews 2013, 113, 2309-2342.
A. Zavalin, E. M. Todd, P. D. Rawhouser, J. Yang, J. L. Norris, R. M. Caprioli, J Mass Spectrom 2012, 47, i.
K. Ščupáková, B. Balluff, C. Tressler, T. Adelaja, R. M. A. Heeren, K. Glunde, G. Ertaylan, Clinical Chemistry and Laboratory Medicine (CCLM) 2020, 58, 914-929.
M. M. Gessel, J. L. Norris, R. M. Caprioli, J Proteomics 2014, 107, 71-82.
L. Jadoul, C. Malherbe, D. Calligaris, R. Longuespée, B. Gilbert, G. Eppe, E. De Pauw, European Journal of Lipid Science and Technology 2014, 116, 1080-1086.
M. Köhler, S. Machill, R. Salzer, C. Krafft, Analytical and bioanalytical chemistry 2009, 393, 1513-1520.
I. Alessandri, I. Vassalini, M. Bertuzzi, N. Bontempi, M. Memo, A. Gianoncelli, Scientific Reports 2016, 6, 34521.
A. Ali, Y. Abouleila, A. Germond, JoVE (Journal of Visualized Experiments) 2020, e60449.
M. D. Nešić, T. Dučić, M. Algarra, I. Popović, M. Stepić, M. Gonçalves, M. Petković, Cancers 2022, 14, 1182.
S. A. Jakab, L. Sementé, M. García-Altares, X. Correig, P. Ràfols, BMC Bioinformatics 2020, 21, 448.
T. W. Bocklitz, A. C. Crecelius, C. Matthäus, N. Tarcea, F. von Eggeling, M. Schmitt, U. S. Schubert, J. Popp, Analytical Chemistry 2013, 85, 10829-10834.
S. A. Jakab, P. Ràfols, X. Correig-Blanchar, M. García-Altares, Analytical Chemistry 2021, 93, 6301-6310.
E. K. Neumann, K. V. Djambazova, R. M. Caprioli, J. M. Spraggins, Journal of the American Society for Mass Spectrometry 2020, 31, 2401-2415.
S.-A. Jakab, G. Baquer, M. Lafuente, M. P. Pina, J. L. Ramírez, P. Ràfols, X. Correig-Blanchar, M. García-Altares, Analytical chemistry 2022, 94, 2785-2793.
A. Braz, M. López-López, C. García-Ruiz, Forensic Science International 2014, 245, 38-44.
P. Hildebrandt, M. Stockburger, The Journal of Physical Chemistry 1984, 88, 5935-5944.
C. Binant, B. Guineau, A. Lautié, Journal of the Society of Dyers and Colourists 1990, 106, 187-191.
A. Colombini, D. Kaifas, Preservation Science 2010, 7, 14-21.
P. Ropret, S. A. Centeno, P. Bukovec, Spectrochimica Acta Part A: Molecular and Biomolecular Spectroscopy 2008, 69, 486-497.
P. Vandenabeele, L. Moens, H. G. M. Edwards, R. Dams, Journal of Raman Spectroscopy 2000, 31, 509-517.
M. d. R. Marcelino, V. S. F. Muralha, Journal of Raman Spectroscopy 2012, 43, 1281-1292.
J. Gu, C. Luo, W. Zhou, Z. Tong, H. Zhang, P. Zhang, X. Ren, Ultrason Sonochem 2020, 68, 105181.
L. J. Soltzberg, A. Hagar, S. Kridaratikorn, A. Mattson, R. Newman, J Am Soc Mass Spectrom 2007, 18, 2001-2006.
V. Huynh, U. Joshi, J. M. Leveille, T. D. Golden, G. F. Verbeck, Forensic Science International 2014, 242, 150-156.
J. A. Barry, M. R. Groseclose, S. Castellino, Bioanalysis 2019, 11, 1099-1116.
T. Bocklitz, K. Bräutigam, A. Urbanek, F. Hoffmann, F. von Eggeling, G. Ernst, M. Schmitt, U. Schubert, O. Guntinas-Lichius, J. Popp, Analytical and Bioanalytical Chemistry 2015, 407, 7865-7873.
D. R. Ahlf, R. N. Masyuko, A. B. Hummon, P. W. Bohn, Analyst 2014, 139, 4578-4585.
R. E. Bulger, The Anatomical Record 1973, 177, 393-407.
C. Delrue, M. M. Speeckaert, in Journal of Personalized Medicine, Vol. 12, 2022.
V. Castiglione, P.-Y. Sacré, E. Cavalier, P. Hubert, R. Gadisseur, E. Ziemons, PLOS ONE 2018, 13, e0201460.
S. Gulyamov, M. Shamshiddinova, W.-H. Bae, Y. C. Park, H. J. Kim, W.-B. Cho, Y.-M. Lee, Journal of Raman Spectroscopy 2021, 52, 1712-1721.
J. Dybas, K. M. Marzec, M. Z. Pacia, K. Kochan, K. Czamara, K. Chrabaszcz, E. Staniszowska-Slczak, K. Malck, M. Baranska, A. Kaczor, TrAC Trends in Analytical Chemistry 2016, 85, 117-127.
C. Krafft, L. Neudert, T. Simat, R. Salzer, Spectrochimica Acta Part A: Molecular and Biomolecular Spectroscopy 2005, 61, 1529-1535.
A. Heintz, S. Sold, F. Wühler, J. Dyckow, L. Schirmer, T. Beuermann, M. Rädle, Applied Sciences 2021, 11, 4777.
A. Wesełucha-Birczyńska, J. Sacharz, J. Zięba-Palus, M. H. Lewandowski, R. Kowalski, K. Palus, Ł. Chrobok, M. Birczyńska, A. Sozańska, Vibrational Spectroscopy 2016, 85, 48-54.
K. Kochan, K. Chrabaszcz, B. Szczur, E. Maslak, J. Dybas, K. M. Marzec, Analyst 2016, 141, 5329-5338.
S. N. Jackson, H. Y. Wang, A. S. Woods, J Am Soc Mass Spectrom 2007, 18, 17-26.
S. N. Jackson, H. Y. Wang, A. S. Woods, Anal Chem 2005, 77, 4523-4527.
J. Martinez-Gardeazabal, E. Gonzalez de San Roman, M. Moreno-Rodriguez, A. Llorente-Ovejero, I. Manuel, R. Rodriguez-Puertas, Biochim Biophys Acta Biomembr 2017, 1859, 1548-1557.
I. Kaya, E. Jennische, S. Lange, P. Malmberg, Anal Methods 2018, 10, 2428-2435.
H. J. Butler, L. Ashton, B. Bird, G. Cinque, K. Curtis, J. Dorney, K. Esmonde-White, N. J. Fullwood, B. Gardner, P. L. Martin-Hirsch, M. J. Walsh, M. R. McAinsh, N. Stone, F. L. Martin, Nat Protoc 2016, 11, 664-687.
R. W. Schafer, IEEE Signal Processing Magazine 2011, 28, 111-117.
J. Jaumot, A. de Juan, R. Tauler, Chemometrics and Intelligent Laboratory Systems 2015, 140, 1-12.
T. H. Niedermeyer, M. Strohalm, PLoS One 2012, 7, e44913.

Although the foregoing subject matter has been described in some detail by way of illustration and example for purposes of clarity of understanding, it will be understood by those skilled in the art that certain changes and modifications can be practiced within the scope of the appended claims.

That which is claimed:

1. A method for obtaining a Raman spectrum of a sample, the method comprising:
(a) providing a sample;
(b) depositing one or more aromatic additives onto the sample; and
(c) obtaining a Raman spectrum of the sample.

2. The method of claim 1, wherein the one or more aromatic additives have an absorbance ranging from about 250 nm to about 500 nm.

3. The method of claim 1, wherein the one or more aromatic additives comprise a matrix-assisted laser desorption/ionization (MALDI) matrix.

4. The method of claim 3, wherein the MALDI matrix is selected from alpha-cyano-4-hydroxycinnamic acid (CHCA), sinapinic acid (SA) ((2E)-3-(4-hydroxy-3,5-dimethoxyphenyl)prop-2-enoic acid), 2,5-dihydroxybenzoic acid (DHB), 3,4-dihydroxycinnamic acid (DHBA), 2-mercaptobenzothiazole (MBT), trans-3-indoleacrylic acid (IAA), 5-chloro-2-mercaptobenzothiazole (CMBT), 2-hydroxyphenylbenzoic acid (HPBA), 2-amino-4-methyl5-nitropyridine (2a4m5n), 2,6-diydroxyacetophenone (DHAP), trihydroxyacetophenone (THAP), ferulic acid (FA) ((2E)-3-(4-hydroxy-3-methoxyphenyl)prop-2-enoic acid), picolinic acid (PA) (pyridine-2-carboxylic acid), 3-hydroxy picolinic acid (HPA) (3-hydroxypyridine-2-carboxylic acid), caffeic acid (CA), 1,5-diaminonaphthalene (DAN), 9-aminoacridine (9-AA), norharmane (nH), nicotinic acid, pyrozinoic acid, vanillic acid, succinic acid, glycerol, urea, tris buffer (pH 7.3), other cinnamic acid derivatives, and combinations thereof.

5. The method of claim 3, wherein a solution comprises a solvent and the MALDI matrix to be deposited.

6. The method of claim 5, wherein the solvent is selected from acetonitrile, water, methanol, ethanol, propanol, acetone, chloroform, N,N-dimethylformamide, tetrahydrofuran and combinations thereof.

7. The method of claim 5, wherein the solution comprising the MALDI matrix further comprises a counter ion or acid additive.

8. The method of claim 7, wherein the counter ion or acid additive is selected from H₃PO₄, HNO₃, H₂SO₄, HCl, and trifluoroacetic acid (TFA), ammonium-based salts, sodium-based salts, lithium-based salts and potassium-based salts.

9. The method of claim 1, wherein the depositing of the one or more aromatic additives onto the sample is accomplished by manual spraying, manual dry sieve deposition, robotic spraying, sublimation, automatic spot printing, or combinations thereof.

10. The method of claim 1, further comprising at least one of: high-resolution Raman mapping; obtaining a MALDI spectrum of the sample; and/or MALDI imaging.

11.-12. (canceled)

13. The method of claim 1, wherein the sample is snap frozen or heat treated.

14. The method of claim 1, further comprising embedding the sample in an embedding medium, matrix, or resin.

15. (canceled)

16. The method of claim 1, further comprising cryo-sectioning the sample.

17. The method of claim 16, wherein the sample is cryo-sectioned onto an indium tin oxide (ITO)-coated slide gold slides, aluminum oxide slides, or steel plates, among others.

18. The method of claim 1, further comprising chemical derivatization of the sample.

19. The method of claim 1, comprising analyzing one or more intact proteins.

20. The method of claim 1, comprising analyzing one or more tryptic peptides.

21. The method of claim 1, comprising analyzing one or more N-glycans, peptides, lipids, metabolites, drug molecules, and drug metabolites in a spatially resolved manner.

22. The method of claim 1, wherein the sample is selected from an organ, a tissue, a cell, bacteria, fungi, a plant, a fruit, another lifeform, and an inanimate object.

23. The method of claim 1, wherein a Raman signal of the sample with the one or more aromatic compounds deposited thereon is greater than a Raman signal of the sample without the one or more aromatic compounds deposited thereon.
